(19) United States
(12) Patent Application Publication
(10) Pub. No.: US 2013/0185268 A1
(43) Pub. Date: Jul. 18, 2013

(54) METHODS OF COMPRESSING AND STORING DATA AND STORAGE DEVICES USING THE METHODS

(71) Applicant: SAMSUNG ELECTRONICS CO., LTD., Suwon-si (KR)

(72) Inventors: Sang-mok KIM, Seoul (KR); Kyung-ho KIM, Seoul (KR); Dong-gi LEE, Yongin-si (KR); Hyun-chul PARK, Ansan-si (KR); O-tae BAE, Daegu (KR)

(73) Assignee: SAMSUNG ELECTRONICS CO., LTD., Suwon-si (KR)

(21) Appl. No.: 13/730,054

(22) Filed: Dec. 28, 2012

(30) Foreign Application Priority Data
Jan. 17, 2012 (KR) 10-2012-0005279

(51) Int. Cl. G06F 17/30

(52) U.S. Cl. CPC G06F 17/30477
USPC 707/693

(57) ABSTRACT

A method of compressing and storing data may include generating target code words by compressing target data to be stored in a memory device by using an initially set compression algorithm; and/or storing in the memory device the target code words according to a data pattern that is repeated in the target code words. A method of compressing and storing data may include generating target code words by compressing target data to be stored in a memory device by using an initially set compression algorithm; and/or storing in the memory device delta-encoded information obtained by performing delta-encoding on the target code words based on source code words including the data pattern.

### CROSS-REFERENCE TO RELATED APPLICATION(S)

This application claims priority from Korean Patent Application No. 10-2012-0005279, filed on Jan. 17, 2012, in the Korean Intellectual Property Office (KIPO), the entire contents of which are incorporated herein by reference.

### BACKGROUND

1. Field

Example embodiments of the inventive concept may relate to storage devices. Example embodiments of the inventive concept also may relate to methods of compressing and/or storing data by removing repeated data patterns.

2. Description of Related Art

Nonvolatile memory devices are memory devices that may retain stored information even when power is off. Examples of nonvolatile memory devices include flash memories. Since the data storage capacity of a nonvolatile memory device is limited, data is compressed and then stored in order to space-efficiently use a storage area. In order to more space-efficiently use the storage area, there is a demand for a technology that increases a data compression ratio.

### SUMMARY

Example embodiments of the inventive concept may provide methods of compressing and/or storing data in memory devices at increased data compression ratios.

Example embodiments of the inventive concept also may provide storage devices for storing data in memory devices at increased data compression ratios.

In some example embodiments, a method of compressing and storing data may comprise generating target code words by compressing target data to be stored in a memory device by using an initially set compression algorithm; and/or storing in the memory device the target code words, according to a data pattern that is repeated in the target code words, or storing in the memory device delta-encoded information, obtained by performing delta-encoding on the target code words based on source code words including the data pattern.

In some example embodiments, the storing may comprise extracting the data pattern; searching for a storage location of the source code words including the data pattern by using pattern table information; and/or writing to the memory device the target code words or delta-encoded information that is obtained by performing the delta-encoding on the target code words based on the source code words according to a search result of the pattern table information. The pattern table information comprises the data pattern and location information of the memory device about a storage location where code words including the data pattern are stored.

In some example embodiments, the searching may comprise assigning a weight value to the data pattern based on a number of times the data pattern is repeated in the target code words; and/or searching for the source code words in the pattern table information based on the weight value assigned to the data pattern.

In some example embodiments, when a plurality of candidates of the source code words are found in the pattern table information, the source code words may be selected by assigning a priority to a data pattern having a largest weight value.

In some example embodiments, when a plurality of candidates of the source code words are found in the pattern table information, the source code words having a large similarity may be selected from the plurality of candidates of the source code words by considering a length of the data pattern and the weight value.

In some example embodiments, the writing may comprises when the data pattern is not registered in the pattern table information, writing the target code words to the memory device; when the data pattern is registered in the pattern table information, performing delta-encoding on the target code words based on the source code words to obtain the delta-encoded information; and/or writing the delta-encoded information to the memory device.

In some example embodiments, the method may further comprise, when the data pattern is not registered in the pattern table information, registering the data pattern in the pattern table information.

In some example embodiments, when the delta-encoded information is written to the memory device, the data pattern that is used to search for the source code words may not be registered in the pattern table information.

In some example embodiments, the method may further comprise calculating a compression ratio of the target data. When the compression ratio is equal to or greater than a first threshold value, the target code words may be stored in the memory device without performing the delta-encoding.

In some example embodiments, the method may further comprise calculating a match rate of the target code words and the source code words. When the match rate is less than a second threshold value, the target code words may be stored in the memory device.

In some example embodiments, the method may further comprise detecting a file format of the target data. When the file format of the target data is included in a range of an initially set file format, the target code words are stored in the memory device without performing the delta-encoding.

In some example embodiments, the compressed target code words may indicate a repeated data pattern expressed in a form of (offset, length), the delta-encoded information may indicate a common data pattern between the target code words and the source code words expressed in a form of (flag, offset, length), and/or the flag may indicate the existence of a source file.

In some example embodiments, the initially set compression algorithm may comprise a Lempel-Ziv-Storer-Szymanski (LZSS) algorithm.

In some example embodiments, a storage device may comprise a memory device that stores information; and/or a memory controller that performs a process of generating target code words by compressing target data by using an initially set compression algorithm during a write operation performed on the target data, and storing in the memory device the target code words according to a data pattern that is repeated in the target code words or storing in the memory device delta-encoded information that is obtained by performing delta-encoding on the target code words based on source code words including the data pattern.

In some example embodiments, the memory controller may comprise a volatile memory unit that temporarily stores mapping table information and pattern table information; a compressor that inputs the target data and outputs the target code words that are obtained by compressing the target data by using the initially set compression algorithm; and/or a control unit that performs a process of extracting the data pattern when the data pattern is registered in the pattern table information, performing delta-encoding on the target code words to obtain delta-encoded information and writing to the memory device the delta-encoded information based on the source code words read from the memory device by using the pattern table information, and when the data pattern is not registered in the pattern table information, registering in the pattern table information the data pattern and writing the target code words to the memory device.

In some example embodiments, a method of compressing and storing data may comprise generating target code words by compressing target data to be stored in a memory device by using an initially set compression algorithm; and/or storing in the memory device the target code words according to a data pattern that is repeated in the target code words.

In some example embodiments, the storing may comprise extracting the data pattern; searching for a storage location of source code words including the data pattern by using pattern table information; and/or writing to the memory device the target code words. The pattern table information may comprise the data pattern and location information of the memory device about a storage location where code words including the data pattern are stored.

In some example embodiments, the target code words may be written to the memory device when the data pattern is not registered in the pattern table information.

In some example embodiments, a method of compressing and storing data may comprise generating target code words by compressing target data to be stored in a memory device by using an initially set compression algorithm; and/or storing in the memory device delta-encoded information obtained by performing delta-encoding on the target code words based on source code words including the data pattern.

In some example embodiments, the storing may comprise extracting the data pattern; searching for a storage location of the source code words including the data pattern by using pattern table information; and/or writing to the memory device the delta-encoded information that is obtained by performing the delta-encoding on the target code words based on the source code words. The pattern table information may comprise the data pattern and location information of the memory device about a storage location where code words including the data pattern are stored.

In some example embodiments, the searching may comprise assigning a weight value to the data pattern based on a number of times the data pattern is repeated in the target code words; and/or searching for the source code words in the pattern table information based on the weight value assigned to the data pattern.

In some example embodiments, a method delta-encoding may be performed on the target code words based on the source code words to obtain the delta-encoded information and/or the delta-encoded information may be written to the memory device when the data pattern is registered in the pattern table information.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a block diagram illustrating a data storage system according to some example embodiments of the inventive concept;

FIG. 2 is a block diagram illustrating a host device of the data storage system of FIG. 1;

FIG. 3 is a block diagram illustrating a memory controller of a storage device of the data storage system of FIG. 1 according to some example embodiments of the inventive concept;

FIG. 4 is a block diagram illustrating the memory controller of the storage device of the data storage system of FIG. 1 according to some example embodiments of the inventive concept;

FIG. 5 is a block diagram illustrating a storage area of a random access memory (RAM) of the memory controller of any of FIGS. 3 and 4 according to some example embodiments of the inventive concept;

FIG. 6 is a block diagram illustrating a storage area of the RAM of the memory controller of any of FIGS. 3 and 4 according to some example embodiments of the inventive concept;

FIG. 7 is a block diagram illustrating a storage area of a memory device of the storage device of the data storage system of FIG. 1;

FIG. 8 is a block diagram illustrating the memory device of the storage device of the data storage system of FIG. 1;

FIG. 9 is a block diagram illustrating a storage area of the memory device of FIG. 8;

FIG. 10 is a block diagram illustrating a logical hierarchical structure of software of the data storage system of FIG. 1;

FIG. 11 is a conceptual diagram for explaining a method of compressing and storing data in the storage device;

FIG. 12 is a diagram for explaining a method of compressing data by using a Lempel-ziv-Storer-Szymanski (LZSS) algorithm;

FIG. 13 is a diagram for explaining a method of performing delta-encoding on compressed data;

FIG. 14 is a graph illustrating an average compression ratio after delta-encoding is performed on compressed data according to various file formats;

FIG. 15 is a flowchart illustrating a method of compressing and storing data according to some example embodiments of the inventive concept;

FIG. 16 is a flowchart illustrating operation S120 of the method of FIG. 15;

FIG. 17 is a flowchart illustrating operation S220 of operation S120 of FIG. 16;

FIG. 18 is a flowchart illustrating operation S230 of operation S120 of FIG. 16 according to some example embodiments of the inventive concept;

FIG. 19 is a flowchart illustrating operation S230 of operation S120 of FIG. 16 according to some example embodiments of the inventive concept;

FIG. 20 is a flowchart illustrating a method of compressing and storing data according to some example embodiments of the inventive concept;

FIG. 21 is a flowchart illustrating a data write operation performed in the storage device of the data storage system of FIG. 1;

FIG. 22 is a flowchart illustrating a data read operation performed in the storage device of the data storage system of FIG. 1;

FIG. 23 is a block diagram illustrating a computer system according to some example embodiments of the inventive concept;

FIG. 24 is a block diagram illustrating a memory card according to some example embodiments of the inventive concept; and

FIG. 25 is a block diagram illustrating a network system including a data storage system according to some example embodiments of the inventive concept.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

FIG. 1 is a block diagram illustrating a data storage system 1000 according to some example embodiments of the inventive concept.

Referring to FIG. 1, the data storage system 1000 includes a host device 110 and a storage device 120.

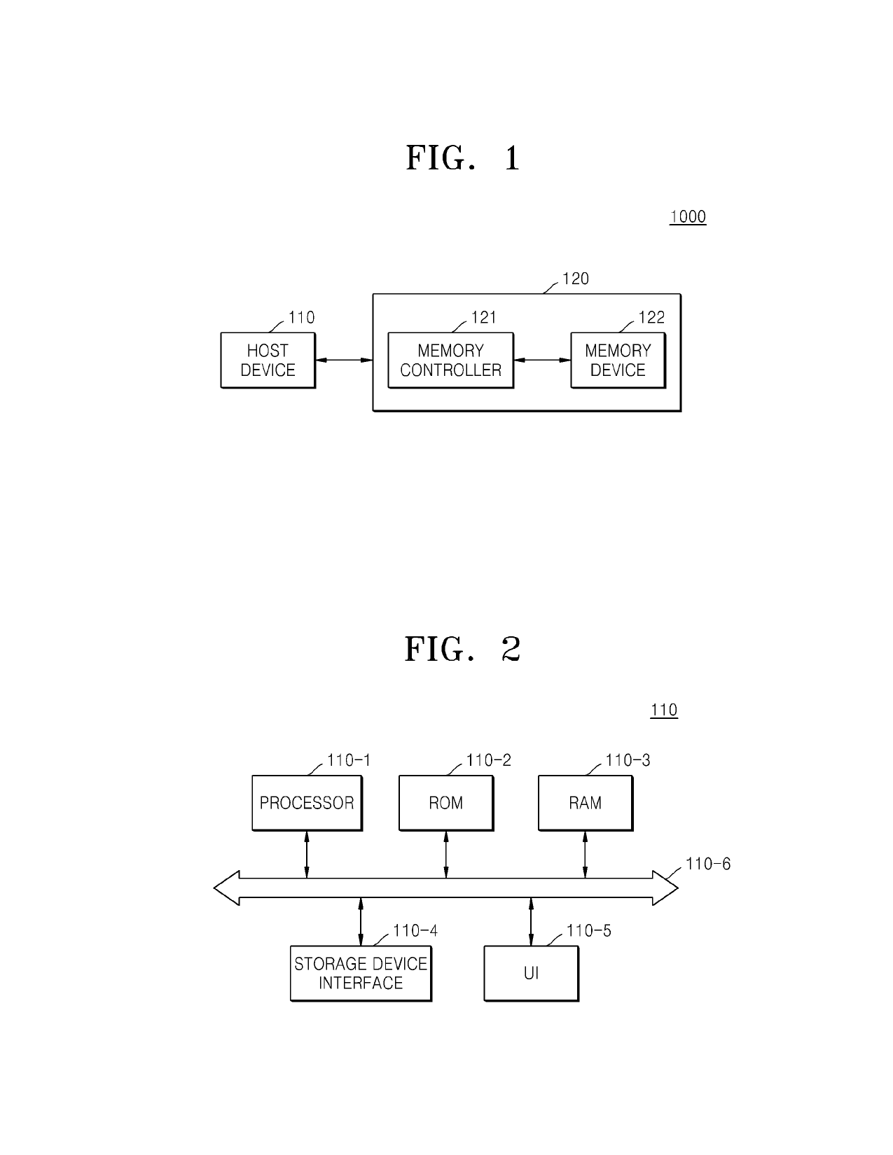

FIG. 2 is a block diagram illustrating the host device 110 of the data storage system 1000 of FIG. 1.

Referring to FIG. 2, the host device 110 includes a processor 110-1, a read-only memory (ROM) 110-2, a RAM 110-3, a storage device interface 110-4, a user interface (UI) 110-5, and a bus 110-6.

The bus 110-6 is a transmission path through which data is transmitted between elements of the host device 110.

Various application programs are stored in the ROM 110-2. For example, application programs that support storage protocols such as advanced technology attachment (ATA), small computer system interface (SCSI), embedded multimedia card (eMMC), and unix file system (UFS) may be stored in the ROM 110-2.

Data or programs are temporarily stored in the RAM 110-3.

The UI 110-5 includes logical software and physical hardware as physical and virtual media for transmitting and receiving information between a user and the host device 110 or a computer program. That is, the UI 110-5 may include an input device through which the user may send a user input to the host device 110 and an output device through which a result obtained after processing the user input is output.

The processor 110-1 controls an overall operation of the host device 110. The processor 110-1 may control the host device 110 to generate a command for storing data in the storage device 120 or a command for reading data from the storage device 120 by using a tool or an application program stored in the ROM 110-2 and to transmit the command to the storage device 120 via the storage device interface 110-4.

The storage device interface 110-4 may include an interface that supports a storage protocols such as an ATA interface, a serial advanced technology attachment (SATA) interface, a parallel advanced technology attachment (PATA) interface, a universal serial bus (USB) interface, a serial attached SCSI (SAS) interface, a SCSI, an eMMC interface, or a UFS interface.

Referring back to FIG. 1, the storage device 120 includes a memory controller 121 and a memory device 122.

A case where the memory device 122 includes a flash memory from among nonvolatile memories will be exemplarily explained. However, memories applied to the memory device 122 are not limited thereto, and various other types of memories may be applied to the memory device 122. For example, examples of a memory applied to the memory device 122 may include a phase-change RAM (PRAM), a ferroelectric RAM (FRAM), and a magnetic RAM (MRAM) as well as a flash memory. The memory device 122 may include a combination of at least one nonvolatile memory and at least one volatile memory, or may include a combination of at least two nonvolatile memories.

For example, if the memory device 122 includes a nonvolatile semiconductor memory such as a flash memory, the storage device 120 may be a solid state drive (SSD).

The memory controller 121 controls an erase operation, a write operation, or a read operation performed on the memory device 122 in response to a command received from the host device 110.

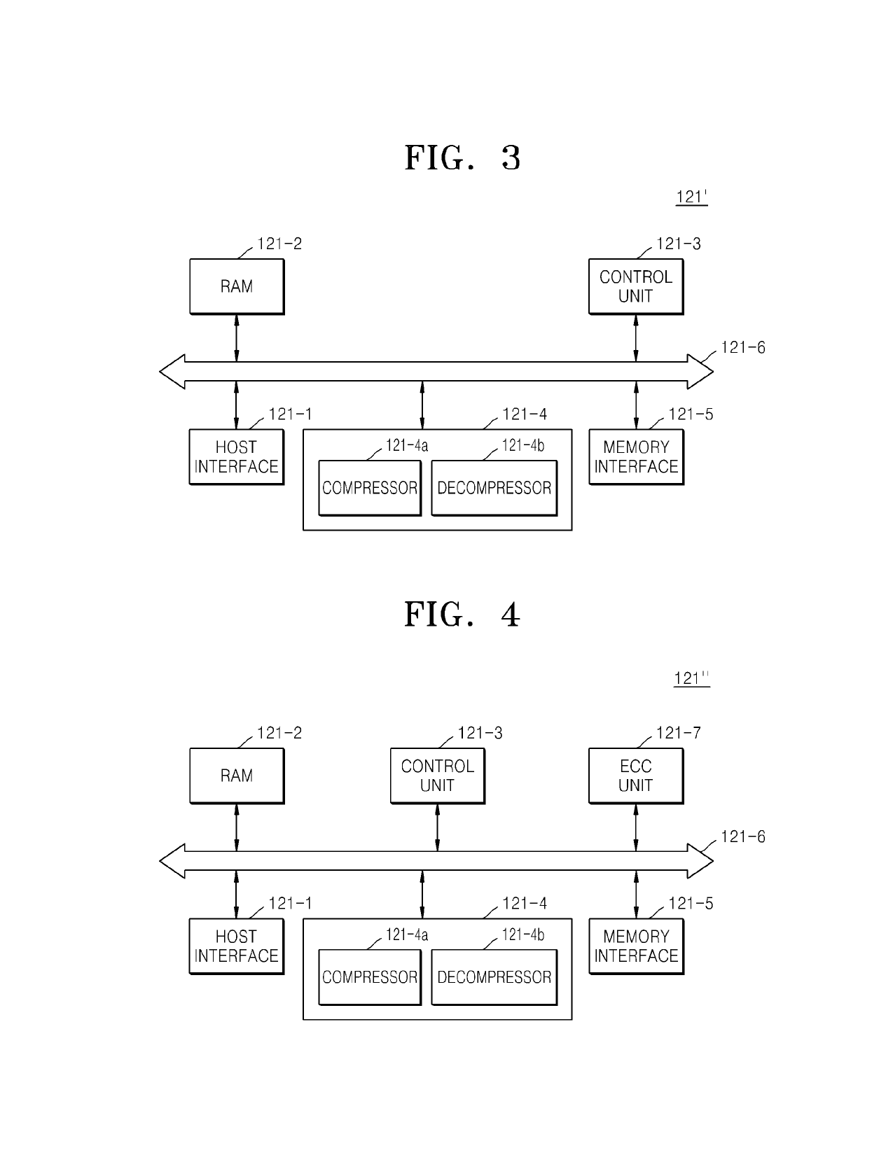

FIG. 3 is a block diagram illustrating the memory controller 121 of the storage device 120 of the data storage system 1000 of FIG. 1, according to some example embodiments of the inventive concept.

The memory controller 121 of FIG. 3 will be denoted by reference numeral 121′. Referring to FIG. 3, the memory controller 121′ includes a host interface 121-1, a RAM 121-2, a control unit 121-3, a compression/decompression unit 121-4, a memory interface 121-5, and a bus 121-6.

For example, each of the control unit 121-3 and the compression/decompression unit 121-4 may be implemented as a single chip. Alternatively, each of the host interface 121-1, the RAM 121-2, the control unit 121-3, the compression/decompression unit 121-4, and the memory interface 121-5 may be implemented as a single chip.

The bus 121-6 is a transmission path through which data is transmitted between elements of the memory controller 121′.

The control unit 121-3 controls an overall operation of the storage device 120. In detail, the control unit 121-3 controls the storage device 120 to analyze a command received from the host device 110 and to operate according to a result of the analysis.

The host interface 121-1 includes a data exchange protocol between the storage device 120 and the host device 110 and connects the storage device 120 and the host device 110. The host interface 121-1 may be any one of an ATA interface, a SATA interface, a PATA interface, a USB interface, an SAS interface, a SCSI, an eMMC interface, and a UFS interface, but the host interface 121-1 is not limited thereto. In detail, the host interface 121-1 exchanges a command, an address, and data with the host device 110 under the control of the control unit 121-3.

Data transmitted from the host device 110 and data generated by the control unit 121-3 are temporarily stored in the RAM 121-2, or data read from the memory device 122 is temporarily stored in the RAM 121-2. Also, metadata read from the memory device 122 is also stored in the RAM 121-2. The RAM 121-2 may be a dynamic RAM (DRAM) or a static RAM (SRAM).

Metadata is information generated by the storage device 120 in order to manage the memory device 122. Mapping table information used to convert a logical address into a physical address of the memory device 122 is included in the metadata. For example, the mapping table information may be information needed to map a logical address to a physical address in units of pages. Information for distinguishing a storage location where delta-encoded information is stored and location information about a storage location where source code words used during delta-encoding corresponding to the storage location where the delta-encoded information is stored are stored may be registered in the mapping table information. In detail, information for distinguishing a physical address at which delta-encoded information is stored from a physical address at which non-delta-encoded information is stored may be added to the mapping table information. A mapping table may be formed such that a physical address at which source code words used during delta-encoding are stored is matched to a physical address at which delta-encoded information is stored. Delta-encoding will be explained below in detail.

Also, pattern table information in which information about a data pattern that is repeated in compressed code words and location information of the memory device about a storage location where code words including the data pattern are stored are registered may be included in the metadata. Information for managing a storage space of the memory device 122 may also be included in the metadata.

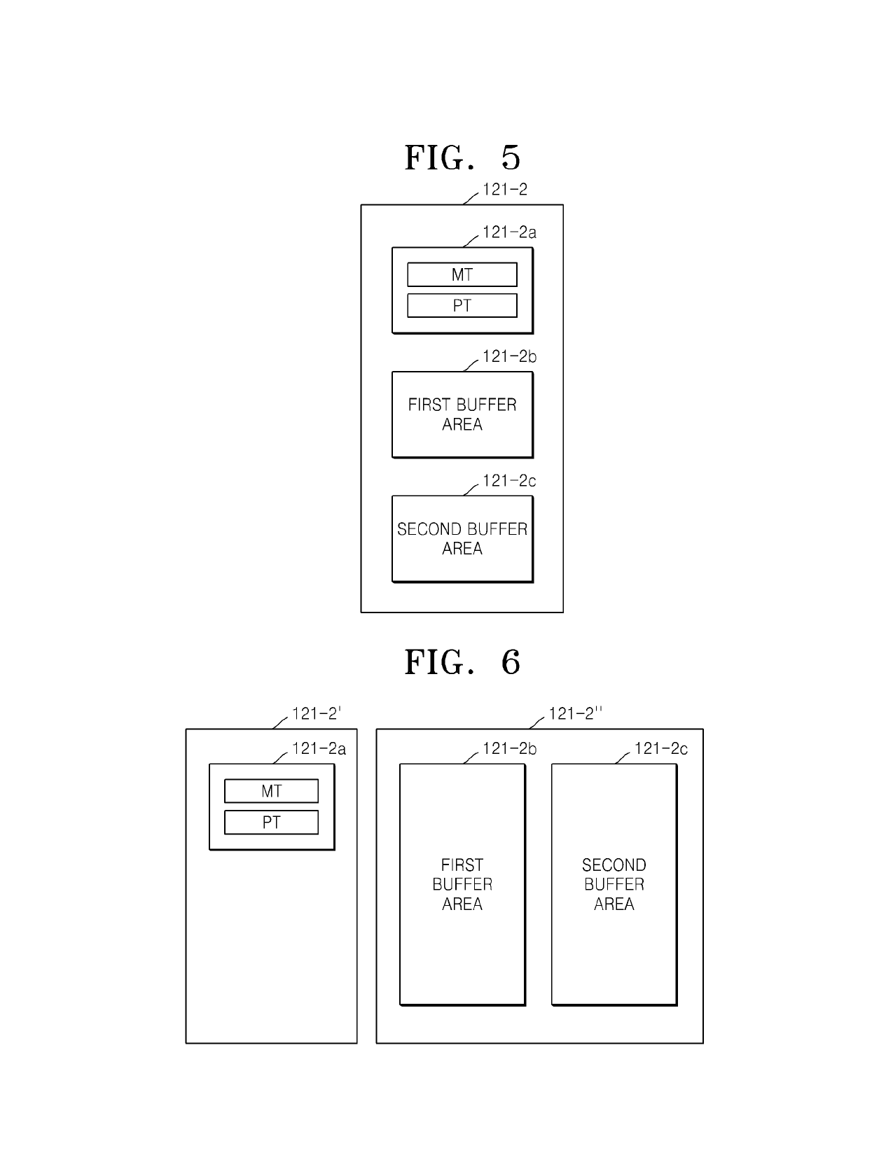

For example, referring to FIG. 5, the RAM 121-2 may be designed to include a metadata storage area 121-2a including mapping table information MT and pattern table information PT in a single chip, a first buffer area 121-2b, and a second buffer area 121-2c.

Alternatively, referring to FIG. 6, the RAM 121-2 may be designed to include a metadata storage area 121-2a including the mapping table information MT and the pattern table information PT in one chip 121-2′, and to include the first buffer area 121-2b and the second buffer area 121-2c in another chip 121-2″.

Referring back to FIG. 3, the compression/decompression unit 121-4 includes a compressor 121-4a and a decompressor 121-4b.

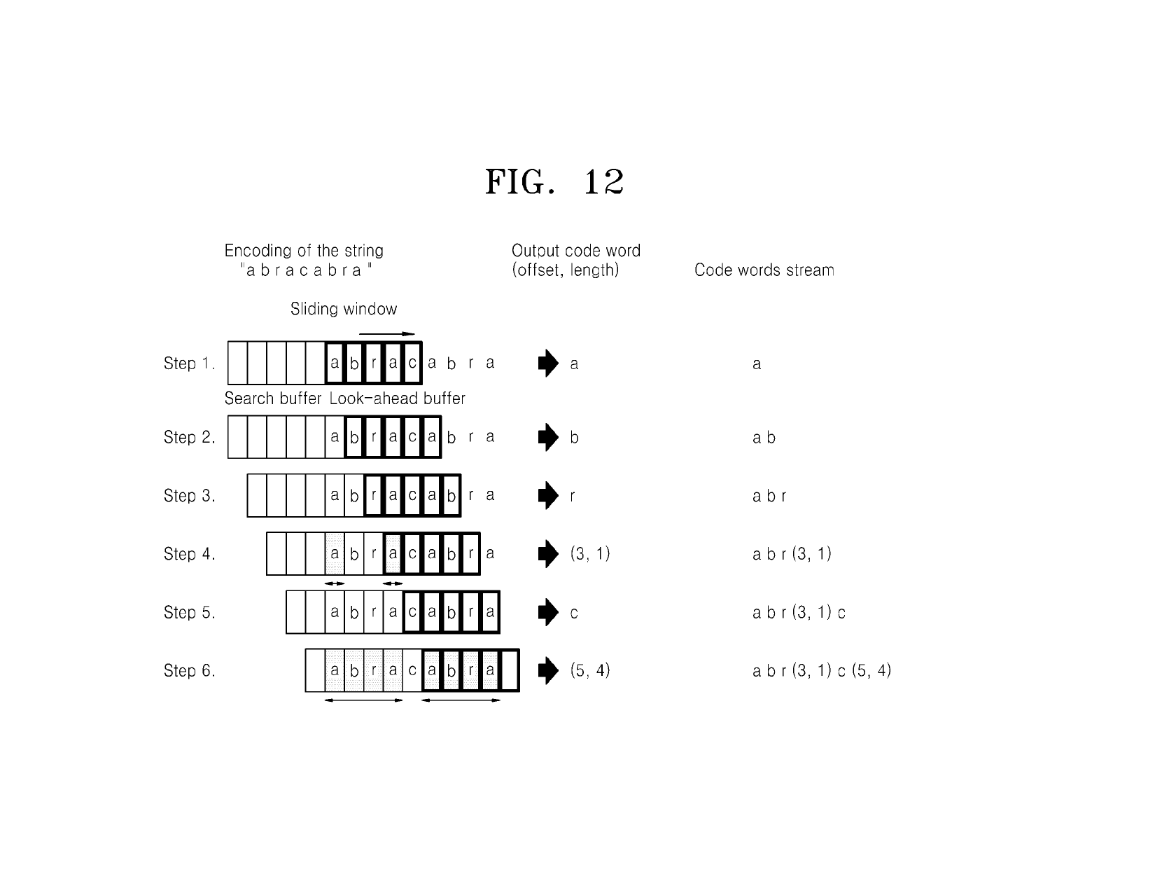

The compressor 121-4a may compress data input thereto by using any of various compression algorithms. For example, the compressor 121-4a may compress data by using a Lempel-Ziv-Storer-Szymanski (LZSS) algorithm and output the compressed data as code words. An example where data is compressed by removing a repeated data pattern by using an LZSS algorithm will be explained with reference to FIG. 12.

In order to use an LZSS algorithm, the compressor 121-4a may include a search buffer and a look-ahead buffer.

It is assumed that a data string that is input to the compressor 121-4a is “a b r a c a b r a”. “a”, “b”, . . . constituting the data string are data in units of bytes. A compression process of the compressor 121-4a will be explained.

In step 1, the data included in the data string are sequentially loaded into the look-ahead buffer. In this step, “a b r a c” is loaded into the look-ahead buffer, and the search buffer remains empty. In this step, since no data is loaded into the search buffer, the compressor 121-4a outputs “a” that is first loaded into the look-ahead buffer as a code word, and the data string is shifted toward the search buffer in units of bytes. A code word stream generated as a result becomes “a”. When the step 1 ends, “a” is loaded into the search buffer and “b r a c a” is loaded into the look-ahead buffer.

In step 2, since data identical to data “b” that is leftmost data in the look-ahead buffer is loaded into the search buffer, the compressor 121-4a outputs a code word “b”. Accordingly, a code word stream generated as a result becomes “a b”. When the step 2 ends, “a b” is loaded into the search buffer and “r a c a b” is loaded into the look-ahead buffer.

In step 3, since data identical to data “r” that is leftmost data in the look-ahead buffer is not loaded into the search buffer, the compressor 121-4a outputs a code word “r”. A code word stream generated as a result becomes “a b r”. When the step 3 ends, “a b r” is loaded into the search buffer and “a c a b r” is loaded into the look-ahead buffer.

In step 4, since data identical to data “a” that is leftmost data in the look-ahead buffer is loaded into an offset 3 position of the search buffer, the compressor 121-4a outputs “(3, 1)” as a value (offset, length) of a code word. A code word stream generated as a result becomes “a b r (3, 1)”. When the step 4 ends, “a b r a” is loaded into the search buffer and “c a b r a” is loaded into the look-ahead buffer.

In step 5, since data identical to data “c” that is leftmost data in the look-ahead buffer is not loaded into the search buffer, the compressor 121-4a outputs a code word “c”. A code word stream generated as a result becomes “a b r (3,1) c”. When the step 5 ends, “a b r a c” is loaded into the search buffer and “a b r a” is loaded into the look-ahead buffer.

In step 6, since data identical to data “a b r a” that is leftmost data in the look-ahead buffer is loaded into an offset 5 position of the search buffer, the compressor 121-4a outputs “(5, 4)” as a value (offset, length) of a code word. A code word stream generated as a result becomes “a b r (3, 1) c (5, 4)”.

Accordingly, a code word stream that is obtained by compressing the data string “a b r a c a b r a” that is input to the compressor 121-4a becomes “a b r (3, 1) c (5, 4)”.

In this manner, the compressor 121-4a may generate code words that are obtained by compressing data that is input to the compressor 121-4a.

Referring back to FIG. 3, the decompressor 121-4b receives compressed data and restores the compressed data to its uncompressed state. The decompressor 121-4b may restore compressed data by reversing the compression process of the compressor 121-4a.

The memory interface 121-5 is electrically connected to the memory device 122. The memory interface 121-5 exchanges a command, an address, and data with the memory device 122 under the control of the control unit 121-3. The memory interface 121-5 may be configured to support a NAND flash memory or a NOR flash memory. The memory interface 121-5 may be configured to selectively perform software and hardware interleaved operations via a plurality of channels.

The control unit 121-3 provides a read command and an address to the memory device 122 during a read operation, and provides a write command, an address, and data to the memory device 122 during a write operation. The control unit 121-3 converts a logical address received from the host device 110 into a physical address by using metadata stored in the RAM 121-2.

When power is supplied to the storage device 120, the control unit 121-3 controls the storage device 120 to read metadata stored in the memory device 122 and to store the metadata in the RAM 121-2. As the metadata stored in the memory device 122 changes, the control unit 121-3 controls the storage device 120 to update the metadata stored in the RAM 121-2. Before the power supplied to the storage device 120 is cut off, the control unit 121-3 controls the metadata stored in the RAM 121-2 to be written to the memory device 122.

The control unit 121-3 performs a process of extracting a data pattern that is repeated in target code words that are obtained by compressing data in the compressor 121-4a, analyzing the data pattern, and storing the target code words in the memory device 122, or reading source code words including the extracted data pattern from the memory device 122, and storing in the memory device 122 delta-encoded information that is obtained by performing delta-encoding on the target code words based on the source code words.

For example, if the data pattern extracted from the target code words is registered in pattern table information, the control unit 121-3 may perform a process of searching for a storage location where the source code words including the data pattern in the pattern table information are stored, reading the storage location from the memory device 122, performing delta-encoding on the target code words based on the source code words to obtain delta-encoded information, and writing the delta-encoded information to the memory device 122. If the data pattern extracted from the target code words is not registered in the pattern table information, the control unit 121-3 may perform a process of registering the data pattern in the pattern table information and writing the target code words to the memory device 122.

FIG. 11 is a conceptual diagram for explaining a method of compressing and storing data in the storage device 120 under the control of the control unit 121-3.

In step 1, in a data write mode, when data is input from the host device 110 to the storage device 120, the compressor 121-4a generates target code words by compressing the data under the control of the control unit 121-3.

Next, in step 2, the control unit 121-3 stores the target code words in the first buffer area 121-2b, and extracts a data pattern that is repeated in the target code words and determines whether the data pattern is registered in pattern table information PT.

When it is determined in step 2 that the data pattern is registered in the pattern table information PT, the control unit 121-3 searches for a storage location where source code words including the data pattern are stored in the pattern table information PT, reads the source code words from the memory device 122 based on the storage location, and stores the source code words in the second buffer area 121-2c. In step 3, the control unit 121-3 performs delta-encoding on the target code words stored in the first buffer area 121-2b based on the source code words stored in the second buffer area 121-2c.

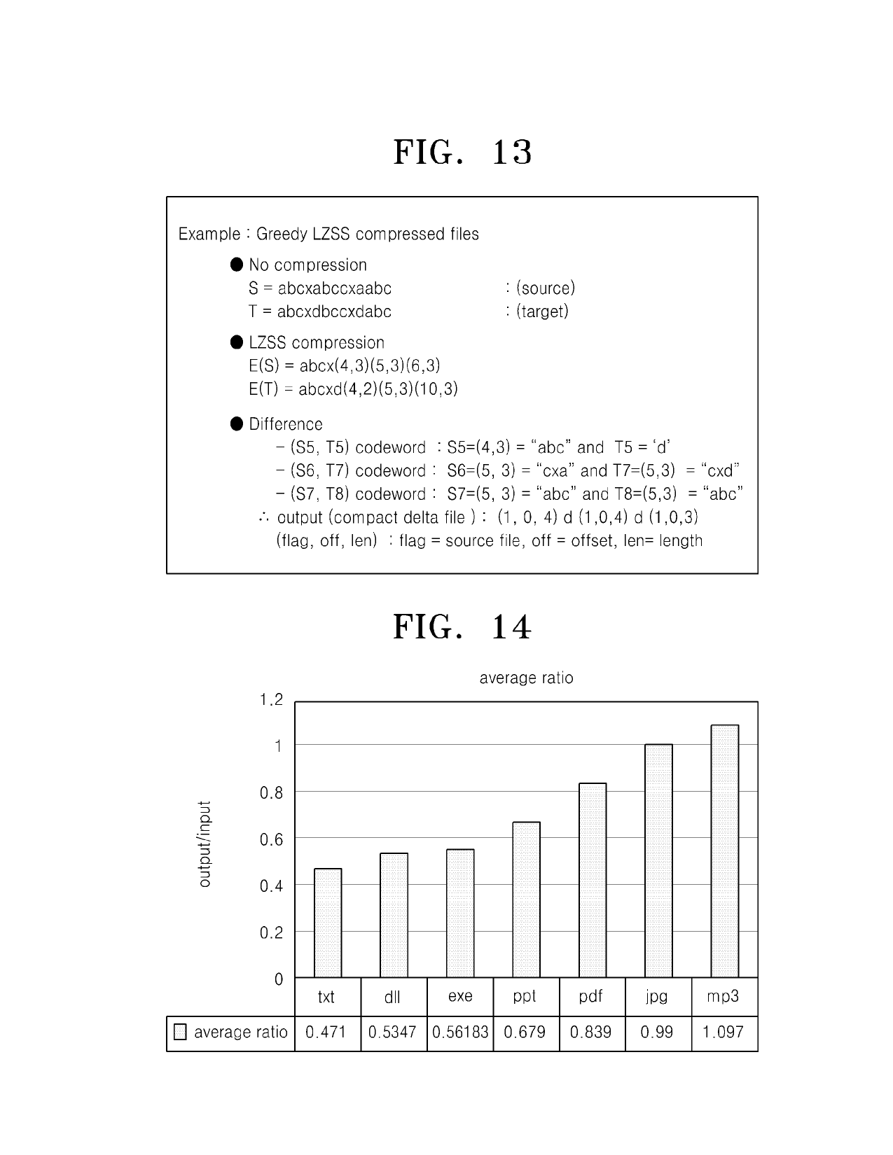

FIG. 13 is a diagram for explaining a method of performing delta-encoding.

Referring to FIG. 13, source code words are denoted by E(S) and target code words are denoted by E(T). For example, it is assumed that E(S)=abcx(4,3)(5,3)(6,3), and E(T)=abcxd(4,2)(5,3)(10,3). The source code words and the target code words are compressed data. Accordingly, source data S that is not compressed and target data T that is not compressed are as shown in FIG. 13. That is, S=abcxabccxaabc and T=abcxdbccxdabc.

A compression result obtained after performing delta-encoding on the target code words E(T) based on the source code words E(S) may be expressed in the form of (flag, offset, length). For example, flag=1 indicates that there exists a source file.

Since S1 through S4 that are a first code word through a fourth code word of the source code words E(S) and T1 through T4 that are a first code word through a fourth code word of the target code words E(T) are both “abcx”, (flag, offset, length)=(1,0,4) may be expressed. T5 that is a fifth code word of the target code words E(T) is “d” and does not exist in the source code words E(S). Accordingly, the fifth code word T5 of the target code words E(T) is not subjected to delta-encoding.

A compression result obtained after performing delta-encoding on the target code words E(T) based on the source code words E(S) by using the method of FIG. 13 becomes (1,0,4)d(1,0,4)d(1,0,3).

Referring back to FIG. 11, the control unit 121-3 performs a process of storing in the memory device 122 delta-encoded information obtained after performing delta-encoding. In step 4, the control unit 121-3 registers the delta-encoded information in mapping table information MT such that a physical address at which the source code words used during the delta-encoding are stored is matched to a physical address of the memory device 122 at which the delta-encoded information is stored.

When it is determined in step 2 that the data pattern that is repeated in the target code words is not registered in the pattern table information PT, the control unit 121-3 performs a process of storing the target code words in the memory device 122 without performing the delta-encoding. The control unit 121-3 120-3 registers in the pattern table information PT information about the data pattern that is repeated in the target code words and location information of the memory device 122 about a storage location where the source code words including the data pattern are stored.

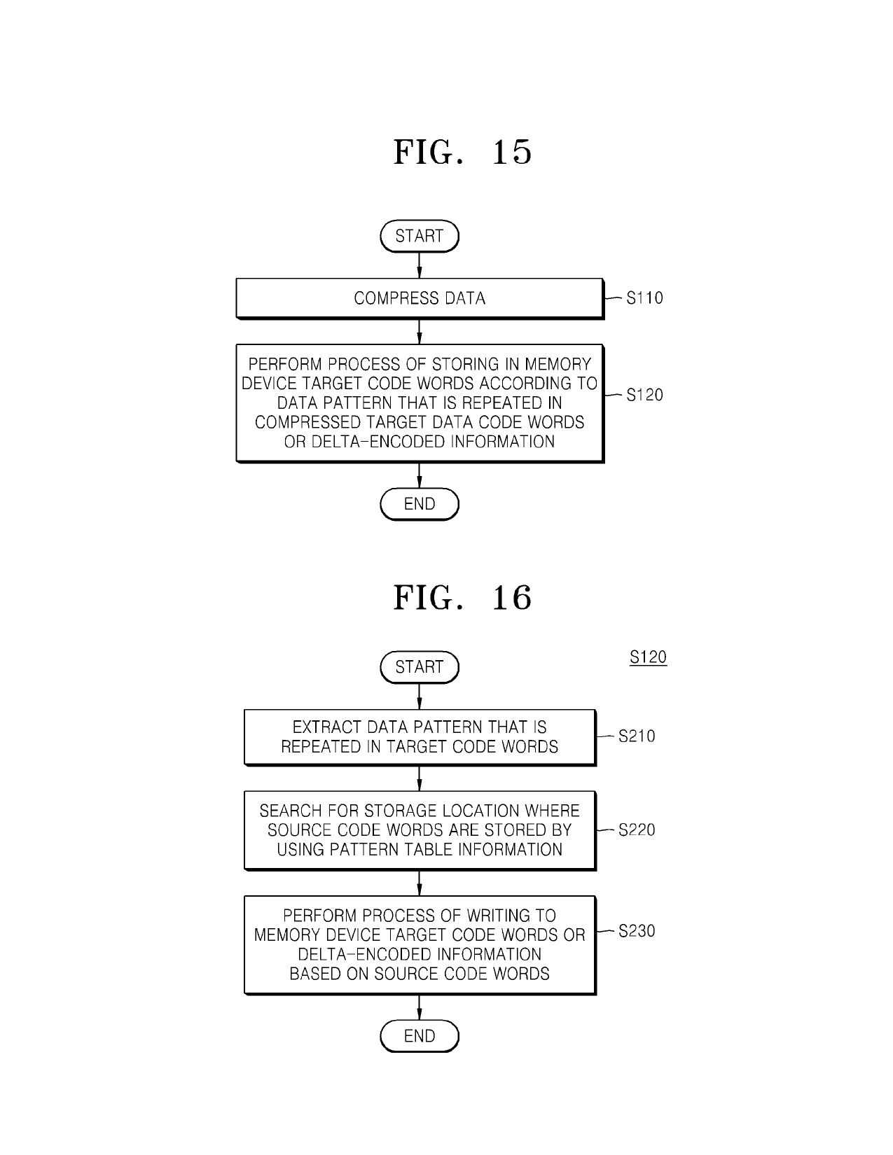

Firmware for performing processes illustrated in flowcharts of FIGS. 15 through 22 is installed in the control unit 121-3. The processes of FIGS. 15 through 22 performed under the control of the control unit 121-3 will be explained below in detail.

FIG. 4 is a block diagram illustrating the memory controller 121 of the storage device 120 of the data storage system 1000 of FIG. 1, according to some example embodiments of the inventive concept.

The memory controller 121 of FIG. 4 will be denoted by reference numeral 121″. Referring to FIG. 4, the memory controller 121″ includes the host interface 121-1, the RAM 121-2, the control unit 121-3, the compression/decompression unit 121-4, the memory interface 121-5, the bus 121-6, and an error correction code (ECC) unit 121-7.

The memory controller 121″ of FIG. 4 additionally includes the ECC unit 121-7 compared to the memory controller 121′ of FIG. 3. Operations of the host interface 121-1, the RAM 121-2, the control unit 121-3, the compression/decompression unit 121-4, the memory interface 121-5, and the bus 121-6 have already been explained with reference to FIG. 3 in detail, and thus a repeated explanation thereof will not be given.

During a write operation, the ECC unit 121-7 may generate an ECC for data to be written by using an algorithm such as a Reed-Solomon (RS) code, a Hamming code, or a cyclic redundancy code (CRC). During a read operation, the ECC unit 121-7 performs error detection and correction on data read from the memory device 122 by using an ECC that is read along with the data. The data to be written may be target code words that are compressed by the compressor 121-4a or delta-encoded information that is obtained by the control unit 121-3.

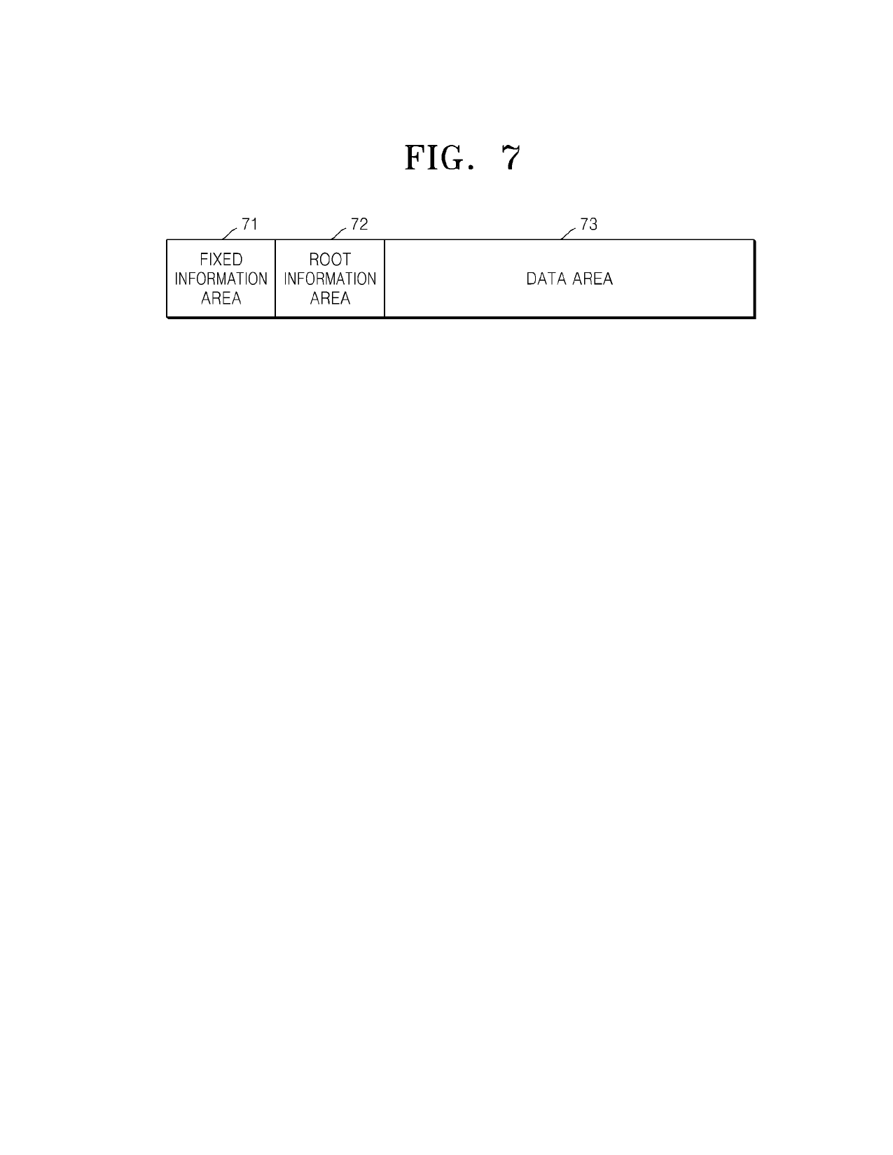

Referring back to FIG. 1, a storage area of the memory device 122 may be divided into a fixed information area 71, a root information area 72, and a data area 73, as shown in FIG. 7.

Unique information of the memory device 122 such as information about a file system, a version, or the number of pages per block may be stored in the fixed information area 71. Location information about a storage location where metadata is stored is stored in the root information area 72. Metadata and user data are stored in the data area 73. The data area 73 may be divided into a metadata storage area and a user data area. The user data area may be divided into a data storage area and a spare area, and an ECC may be stored in the spare area.

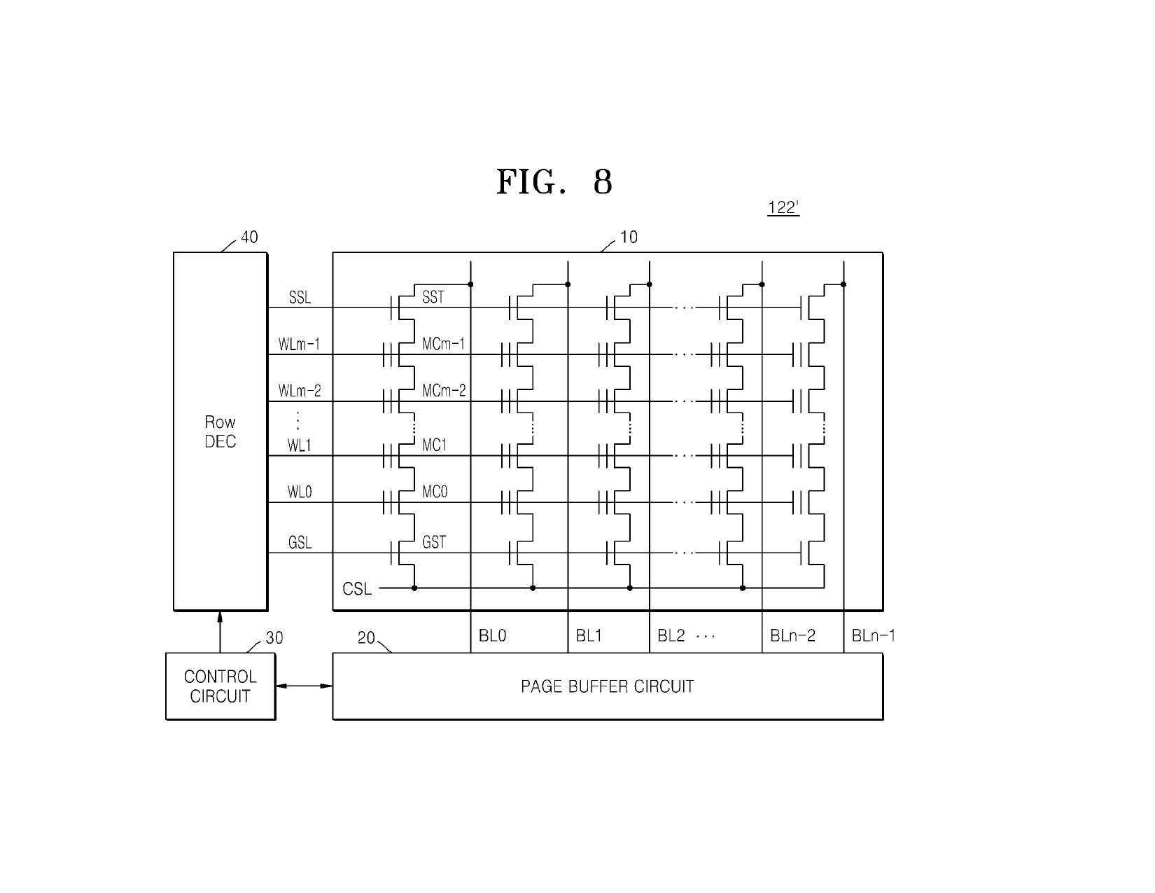

FIG. 8 is a block diagram illustrating the memory device 122 of the storage device 120 of the data storage system 1000 of FIG. 1. It is assumed that the memory device 122 includes a flash memory.

The memory device 122 of FIG. 8 will be denoted by reference numeral 122′. Referring to FIG. 8, the memory device 122′ includes a cell array 10, a page buffer circuit 20, a control circuit 30, and a row decoder 40.

Data is written to the cell array 10 by applying a predetermined voltage to a transistor. The cell array 10 includes memory cells formed at intersections between word lines WL0 through WLm-1 and bit lines BL0 through BLn-1, wherein m and n are natural numbers. Although one memory block is illustrated in FIG. 8, the cell array 10 may include a plurality of memory blocks. Each of the memory blocks includes pages respectively corresponding to the word lines WL0 through WLm-1. Each of the pages includes a plurality of memory cells connected to each of the word lines WL0 through WLm-1. The memory device 122′ performs an erase operation in units of blocks and performs a program operation or a read operation in units of pages.

The cell array 10 has a cell string structure. A cell string includes a string selection transistor SST connected to a string selection line SSL, a plurality of memory cells MC0 through MCm-1 respectively connected to the plurality of word lines WL0 through WLm-1, and a ground selection transistor GST connected to a ground selection line GSL. The string selection transistor SST is connected between a bit line and a string channel, and the ground selection transistor GST is connected between the string channel and a common source line CSL.

The page buffer circuit 20 is connected to the cell array 10 through the plurality of bit lines BL0 through BLn-1. The page buffer circuit 20 temporarily stores data to be written to memory cells connected to a selected word line, or temporarily stores data read from the memory cells connected to the selected word line.

The control circuit 30 generates various voltages needed to perform a program or read operation and an erase operation, and controls an overall operation of the memory device 122′ by receiving control signals.

The row decoder 40 is connected to the cell array 10 through the string selection line SSL, the ground selection line GSL, and the plurality of word lines WL0 through WLm-1. During a write operation or a read operation, the row decoder 40 receives an address, and selects any one word line according to the input address. Memory cells on which a write operation or a read operation is to be performed are connected to a selected word line.

Also, the row decoder 40 applies voltages (for example, a program voltage, a pass voltage, a read voltage, a string selection voltage, and a ground selection voltage) needed to perform a program operation or a read operation to a selected word line, non-selected word lines, and the string selection line SSL and the ground selection line GSL.

Each memory cell may store one bit of data or two or more bits of data. When one bit of data may be stored in each memory cell, the memory cell is called a single-level cell (SLC). When two or more bits of data may be stored in each memory cell, the memory cell is called a multi-level cell (MLC). The SLC has an erase state or a program state according to a threshold voltage.

In particular, a flash memory including MLCs may undergo degradation of reliability and may not use an ECC to correct an error according to a usage time and a program/erase cycle. A spare area exists in a physical page of the flash memory, and ECC information is stored in the spare area.

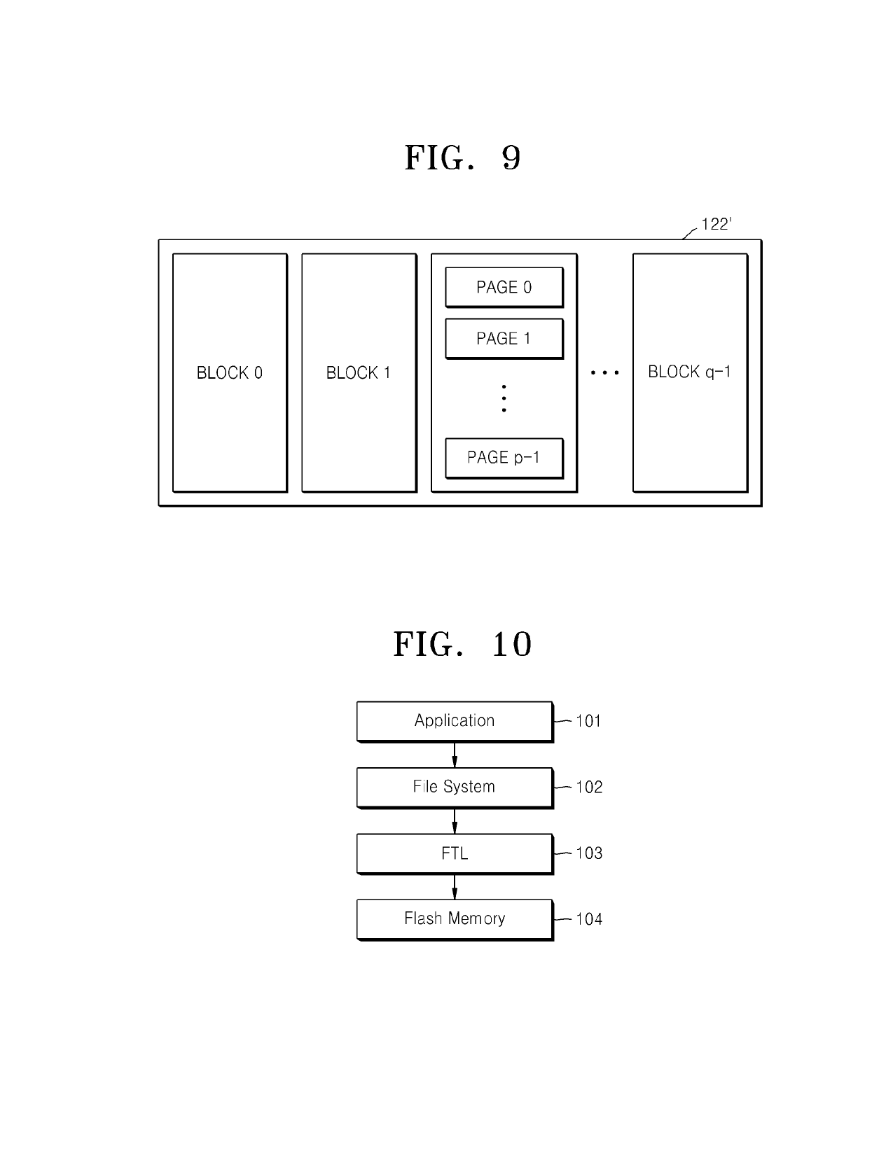

FIG. 9 is a block diagram illustrating a storage area of the memory device 122′ of FIG. 8. Referring to FIG. 9, the storage area of the memory device 122′ includes a plurality of blocks, and each of the blocks includes a plurality of pages. For example, each of the blocks may include 256 pages. Each of the 256 pages may include 16 sectors.

In the memory device 122′, a write operation and a read operation are performed in units of pages, and an erase operation is performed in units of blocks. Also, an erase operation is required to be performed before a write operation is performed. Accordingly, overwrite is impossible.

In a memory device in which overwrite is impossible, a user may not be able to write user data to a desired physical area. Accordingly, when there is a request from a user for an access in order to perform a write or read operation, a process of classifying a physical area where data is actually stored or data is to be stored according to physical addresses and converting a logical address of user data into a physical address is required.

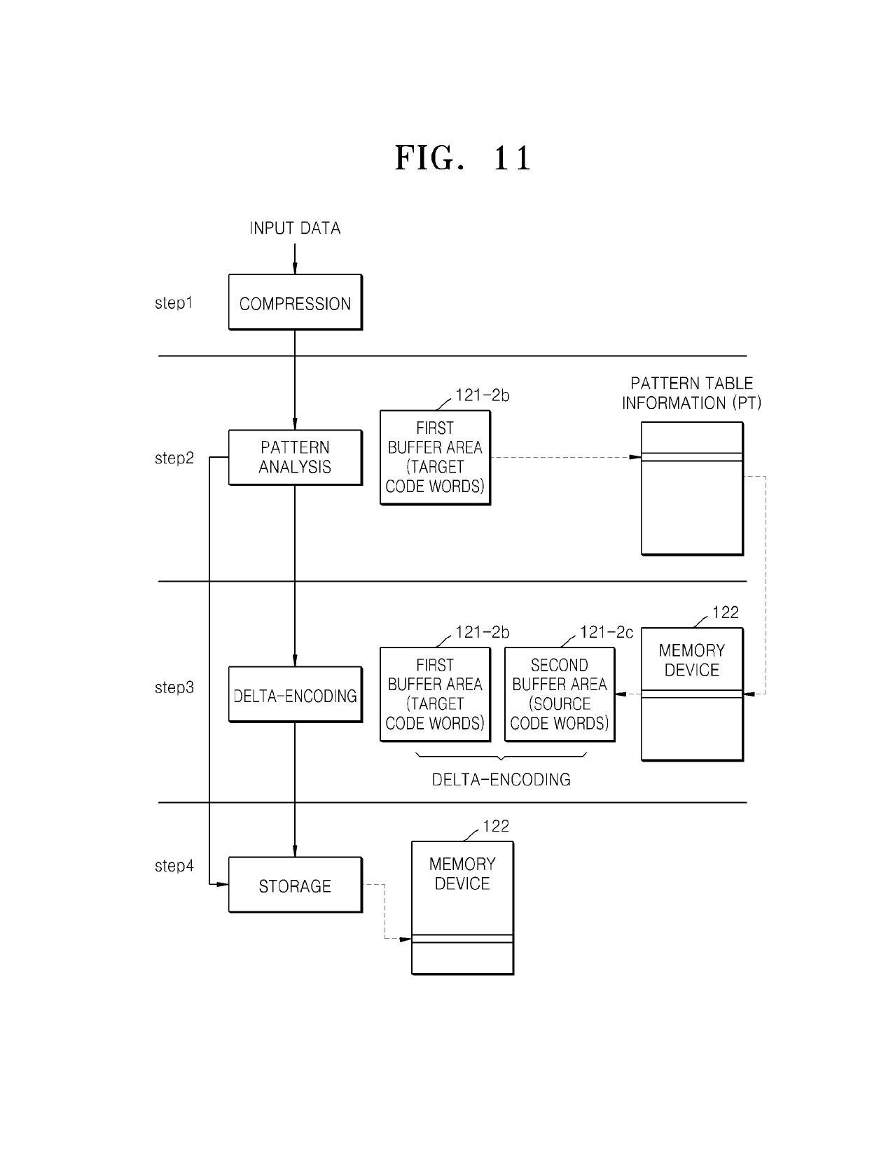

A process of converting a logical address into a physical address in the data storage system 1000 will be explained with reference to FIG. 10.

FIG. 10 is a diagram illustrating a logical hierarchical structure of software of the data storage system 1000 of FIG. 1 when the memory device 122 of the data storage system 1000 includes a flash memory.

Referring to FIG. 10, the data storage system 1000 includes an application 101, a file system 102, a flash translation layer (FTL) 103, and a flash memory 104 in an order listed above. The flash memory 104 may refer to the memory device 122′ of FIGS. 8 and 9.

The application 101 is firmware that processes user data in response to an input of a user via the UI 110-5. For example, the application 101 may be document processing software such as a word processor, calculation software, or a document viewer such as a web browser. The application 101 processes user data in response to an input of a user, and transmits a command for storing the processed user data in the flash memory 104 to the file system 102.

The file system 102 is a structure or software used to store user data in the flash memory 104. The file system 102 assigns a logical address at which user data is to be stored in response to a command from the application 101. Examples of the file system 102 may include a file allocation table (FAT) file system and a new technology file system (NTFS).

The FTL 103 converts a logical address received from the file system 102 into a physical address for a read/write operation of the flash memory 104. The FTL 103 converts a logical address into a physical address by using the mapping table information MT. Examples of an address mapping method include a page mapping method and a block mapping method. The page mapping method is a method of performing an address mapping operation in units of pages, and the block mapping method is a method of performing an address mapping operation in units of blocks. Also, a combination of the page mapping method and the block mapping method may be used. Here, the term physical address refers to a storage location of the flash memory 104 where data is stored.

FIG. 15 is a flowchart illustrating a method of compressing and storing data, according to some example embodiments of the inventive concept. The method of FIG. 15 may be performed under the control of the control unit 121-3 of FIG. 3 or 4.

In a data write mode, in operation S110, when target data to be written is received from the host device 110, the storage device 120 compresses the target data. For example, the control unit 121-3 transmits the target data to the compressor 121-4a and activates the compressor 121-4a. Accordingly, the compressor 121-4a compresses the target data by using, for example, an LZSS algorithm, to obtain a result, and outputs the result in the form of code words. Accordingly, the compressor 121-4a outputs target code words that are obtained by compressing the target data. The compressor 121-4a may use any of various compression algorithms other than the LZSS algorithm.

In operation S120, the control unit 121-3 performs a process of storing in the memory device 122 the target code words according to a data pattern that is repeated in the target code words obtained in operation S110, or storing in the memory device 122 delta-encoded information that is obtained by performing delta-encoding on the target code words based on source code words including the data pattern that is repeated in the target code words. FIG. 16 is a flowchart illustrating operation S120 of the method of FIG. 15.

Operation S120 of the method of FIG. 15 will be explained with reference to FIG. 16.

In operation S210, the control unit 121-3 inputs the target code words obtained in operation S110, and extracts the data pattern that is repeated in the target code words.

In operation S220, the control unit 121-3 searches for a storage location where the source code words including the data pattern that is repeated in the target code words by using the pattern table information PT stored in the RAM 121-2.

In operation S230, the control unit 121-3 performs a process of writing to the memory device 122 the delta-encoded information that is obtained by performing delta-encoding on the target code words based on the source code words or writing to the memory device 122 the target code words.

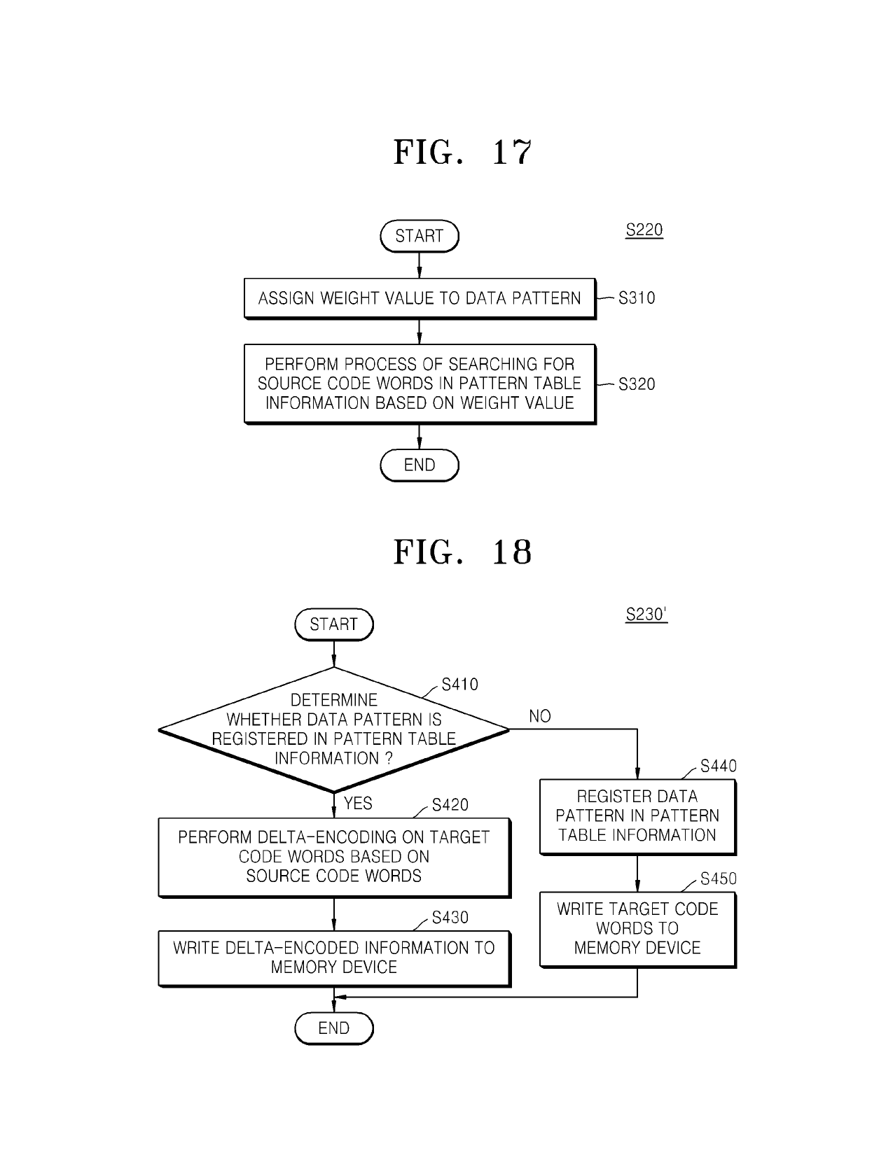

FIG. 17 is a flowchart illustrating operation S220 of operation S120 of FIG. 16.

In S310, the control unit 121-3 assigns a weight value to the data pattern extracted in operation S210. For example, the weight value may be assigned to the data pattern based on the number of times the data pattern is repeated in the target code words. For example, (3, 1) and (5, 4) in target code words “a b r (3, 1) c (5, 4)” in FIG. 12 each refer to a data pattern that is repeated once or more. For example, when (3, 1) in the target code words “a b r (3, 1) c (5, 4)” is repeated three times and (5, 4) is repeated two times, a weight value of 3 may be assigned to the data pattern (3, 1) and a weight value of 2 may be assigned to the data pattern (5, 4).

In operation S320, the control unit 121-3 performs a process of searching for the source code words in the pattern table information PT based on the weight value assigned to the data pattern. For example, when a plurality of candidates of the source code words are found in the pattern table information PT, one or more source code words may be selected from the source code words by assigning a priority to a data pattern having a large weight value. That is, code words including a data pattern having a largest weight value may be selected from among the source code words.

Alternatively, when a plurality of candidates of the source code words are found in the pattern table information PT, source code words having a large similarity may be selected from among the source code words by considering the weight value and a length of the data pattern. For example, when a weight value of 3 is assigned to the data pattern (3, 1) and a weight value of 2 is assigned to the data pattern (5, 4), a length of the data pattern (3, 1) is 1 and a length of the data pattern (5, 4) is 4. Accordingly, a result obtained after multiplying a weight value by a length is “3” for the data pattern (3, 1) and “8” for the data pattern (5, 4). It is found that source code words including the data pattern (5, 4) have a higher similarity than source code words including the data pattern (3, 1). Accordingly, the source code words including the data pattern (5, 4) may be found.

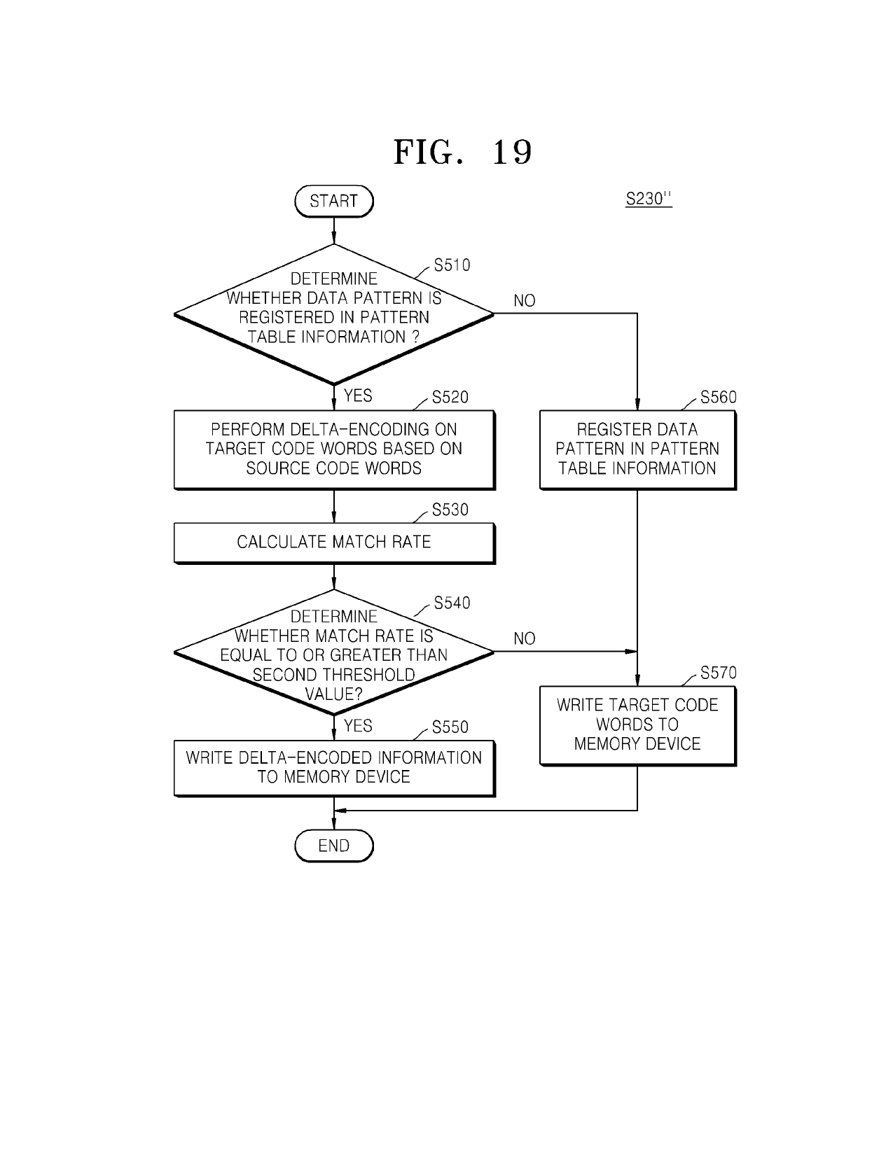

FIG. 18 is a flowchart illustrating operation S230 of operation S120 of FIG. 16, according to some example embodiments of the inventive concept. Operation S230 of FIG. 18 will be denoted by reference numeral S230′.

In operation S410, the control unit 121-3 determines whether the data pattern extracted in operation S210 is registered in the pattern table information PT as a search result of operation S220 of FIG. 16.

When it is determined in operation S410 that the data pattern is registered in the pattern table information PT, operation S230′ proceeds to operation S420. In operation S420, the control unit 121-3 performs delta-encoding on the target code words based on the source code words to obtain delta-encoded information. A method of performing delta-encoding has already been explained in FIG. 13 in detail, and thus a repeated explanation thereof will not be given.

In operation S430, the control unit 121-3 performs a process of writing the delta-encoded information to the memory device 122. In this case, the control unit 121-3 registers in the mapping table information MT a physical address of the memory device 122 at which the delta-encoded information is stored and a physical address at which the source code words used during the delta-encoding are stored.

Otherwise, when it is determined in operation S410 that the data pattern is not registered in the pattern table information PT, operation S230′ proceeds to operation S440. In operation S440, the control unit 121-3 registers in the pattern table information PT the data pattern that is extracted in operation S210 of FIG. 16. For example, the control unit 121-3 registers in the pattern table information PT information about the data pattern that is repeated in the target code words and location information of the memory device 122 about a storage location where the source code words including the data pattern are stored.

In operation S450, the control unit 121-3 performs a process of writing the target code words to the memory device 122.

FIG. 19 is a flowchart illustrating operation S230 of operation S120 of FIG. 16, according to some example embodiments of the inventive concept. Operation S230 of FIG. 19 will be denoted by reference numeral S230″.

In operation S510, the control unit 121-3 determines whether the data pattern extracted in operation S210 is registered in the pattern table information PT as a search result of operation S220 of FIG. 16.

When it is determined in operation 5510 that the data pattern is registered in the pattern table information PT, operation S230″ proceeds to operation S520. In operation S520, the control unit 121-3 performs delta-encoding on the target code words based on the source code words to obtain delta-encoded information. A method of performing delta-encoding has already been explained in FIG. 13 in detail, and thus a repeated explanation thereof will not be given.

In operation S530, the control unit 121-3 calculates a match rate of the source code words and the target code words during the delta-encoding. For example, the match rate may be calculated by dividing the number of same bytes between the source code words and the target code words by the number of bytes included in the target code words.

In operation S540, the control unit 121-3 determines whether the match rate is equal to or greater than a second threshold value. The second threshold value may be initially set to a value greater than a minimum match rate at which a data compression ratio may be increased through delta-encoding.

When it is determined in operation S540 that the match rate is equal to or greater than the second threshold value, operation S230″ proceeds to operation S550. In operation S550, the control unit 121-3 performs a process of writing the delta-encoded information to the memory device 122. In this case, the control unit 121-3 registers in the mapping table information MT a physical address at which the source code words used during the delta-encoding are stored and a physical address of the memory device 122 at which the delta-encoded information is stored.

Otherwise, when it is determined in operation S510 that the data pattern is not registered in the pattern table information PT, operation S230″ proceeds to operation S560. In operation S560, the control unit 121-3 registers in the pattern table information PT the data pattern extracted in operation S210. For example, the control unit 121-3 registers in the pattern table information PT information about the data pattern that is repeated in the target code words and location information of the memory device 122 about a storage location where the source code words including the data pattern are stored.

Otherwise, when it is determined in operation S540 that the match rate is less than the second threshold value, operation S230″ proceeds to operation S570. In operation S570, the control unit 121-3 performs a process of writing the target code words to the memory device 122.

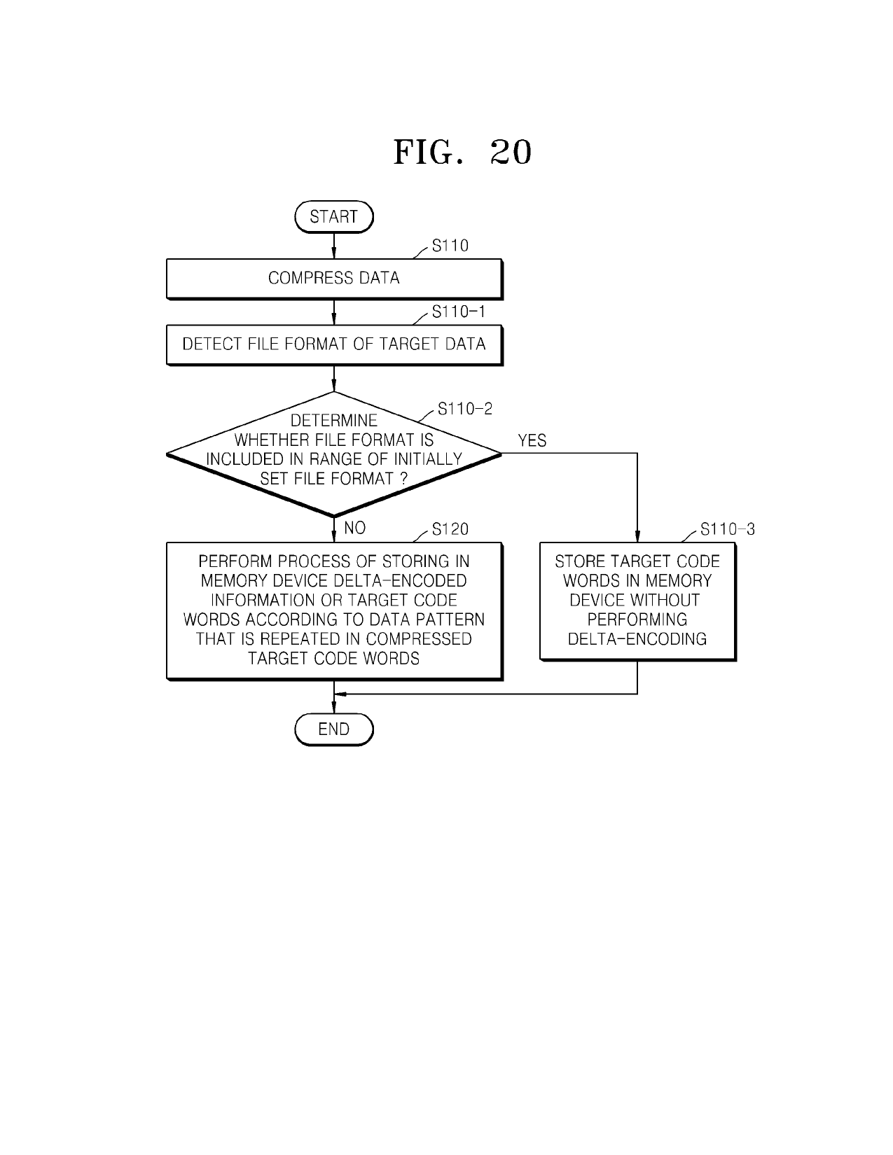

FIG. 20 is a flowchart illustrating a method of compressing and storing data according to some example embodiments of the inventive concept. The method of FIG. 20 may be performed under the control of the control unit 121-3 of FIG. 3 or 4.

In operation S110, in a data write mode, when target data to be written is received from the host device 110, the storage device 120 compresses the target data. A process of compressing the target data is substantially the same as operation S110 of the method of FIG. 15, and thus a repeated explanation thereof will not be given.

In operation S110-1, the control unit 121-3 detects a file format of the target data input to the storage device 120. For example, the file format of the target data may be detected by detecting file extension information. The file extension information of the target data to be written may be transmitted to the storage device 120 from the host device 110, and the storage device 120 may detect the file format by using the file extension information transmitted from the host device 110.

In operation S110-2, the control unit 121-3 determines whether the file format of the target data is included in a range of an initially set file format. File formats that have compression ratios that are equal to or greater than a first threshold value after delta-encoding may be included in the range of the initially set file format. The term compression ratio refers to a value obtained by dividing a size of delta-encoded output data by a size of input data.

FIG. 14 is a graph illustrating an average compression ratio after delta-encoding according to file formats. Referring to FIG. 14, since a file format mp3 has an average compression ratio greater than 1, a size of delta-encoded output data is greater than a size of input data. Accordingly, a file format mp3 that is not subjected to delta-encoding may further reduce a size of data than a file format mp3 that is subjected to delta-encoding. When the first threshold value is set to 0.8 in FIG. 14, file formats such as pdf, jpg, and mp3 may be included in the range of the initially set file format.

When it is determined in operation S110-2 that the file format of the target data is included in the range of the initially set file format, the method proceeds to operation S110-3. In operation S110-3, the control unit 121-3 performs a process of storing in the memory device 122 the target code words that are compressed in operation 5110 without performing the delta-encoding.

Otherwise, when it is determined in operation S110-2 that the file format of the target data that is detected is not included in the range of the initially set file format, the method proceeds to operation S120. In operation S120, the control unit 121-3 performs a process of storing in the memory device 122 the target code words according to the data pattern that is repeated in the target code words that are compressed in operation S110 or storing in the memory device 122 delta-encoded information that is obtained by performing delta-encoding on the target code words based on the source code words including the data pattern that is repeated in the target code words. Operation S120 is substantially the same as operation S120 of FIG. 15, and thus a repeated explanation thereof will not be given.

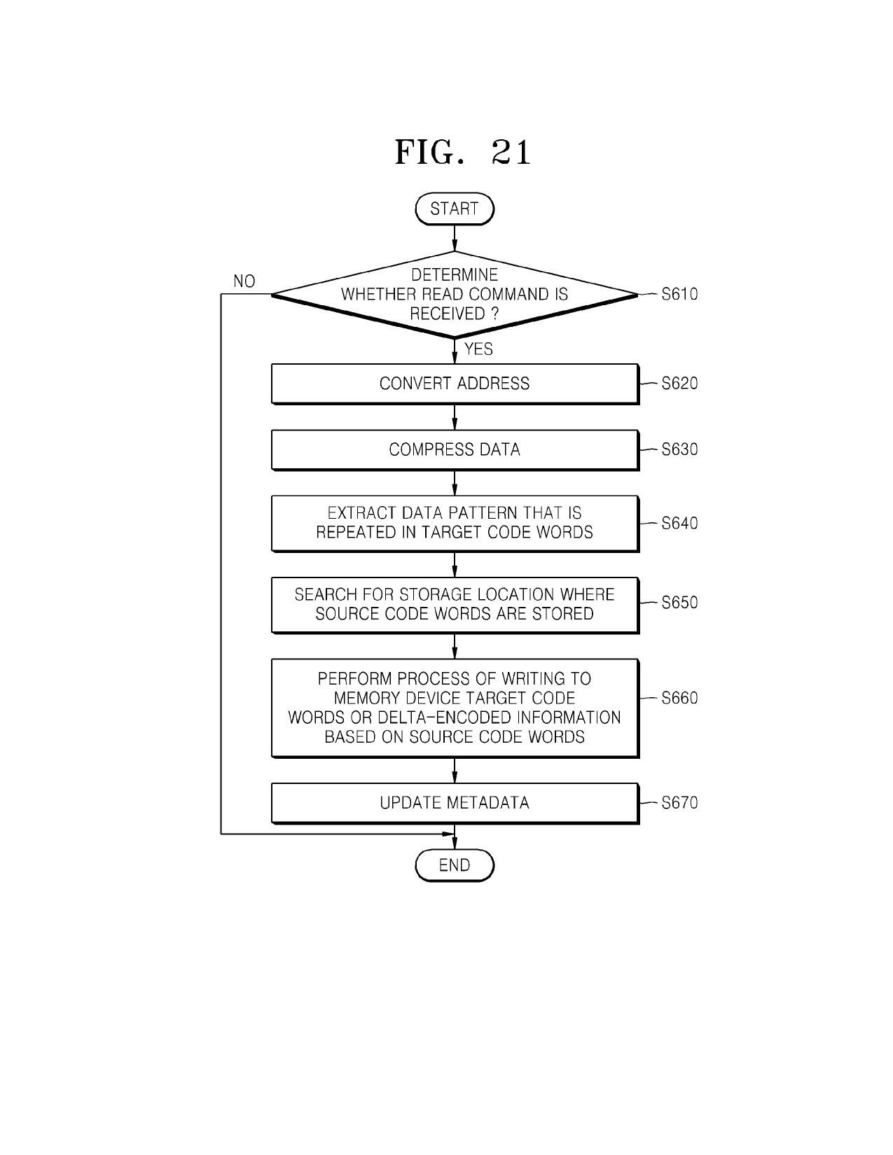

FIG. 21 is a flowchart illustrating a data write operation performed in the storage device 120 of the data storage system 1000 of FIG. 1. The method of FIG. 21 may be performed under the control of the control unit 121-3 of FIG. 3 or 4.

In operation S610, the control unit 121-3 determines whether a write command is received from the host device 110 to the storage device 120.

When it is determined in operation S610 that the write command is received from the host device 110 to the storage device 120, the data write operation proceeds to operation S620. In operation S620, the control unit 121-3 converts a logical address into a physical address by using the mapping table information MT. For example, when the memory device 122 includes a flash memory, a logical address is converted into a physical page number.

In operation S630, the compressor 121-4a of the storage device 120 compresses data received from the host device 110. Operation S630 is substantially the same as operation S110 of the method of FIG. 15, and thus a repeated explanation thereof will not be given.

In operation S640, the control unit 121-3 inputs the target code words that are compressed in operation S630, and extracts the data pattern that is repeated in the input target code words.

In operation S650, the control unit 121-3 searches for a storage location of the source code words including the data pattern that is repeated in the target code words by using the pattern table information PT stored in the RAM 121-2.

In operation S660, the control unit 121-3 performs a process of writing to the memory device 122 delta-encoded information that is obtained by performing delta-encoding on the target code words based on the source code words or writing to the memory device 122 the target code words. Operation S660 is substantially the same as operation S230 of operation S120 of FIG. 16, and thus a repeated explanation thereof will not be given.

In operation S670, the control unit 121-3 updates metadata. For example, when the delta-encoded information is stored, a physical address of the memory device 122 at which the delta-encoded information is stored and a physical address at which the source code words used during the delta-encoding are stored may be registered in the mapping table information MT. When the target code words are stored, information about the data pattern that is repeated in the target code words and location information of the memory device 122 about a storage location where the code words including the data pattern are stored are registered in the pattern table information PT.

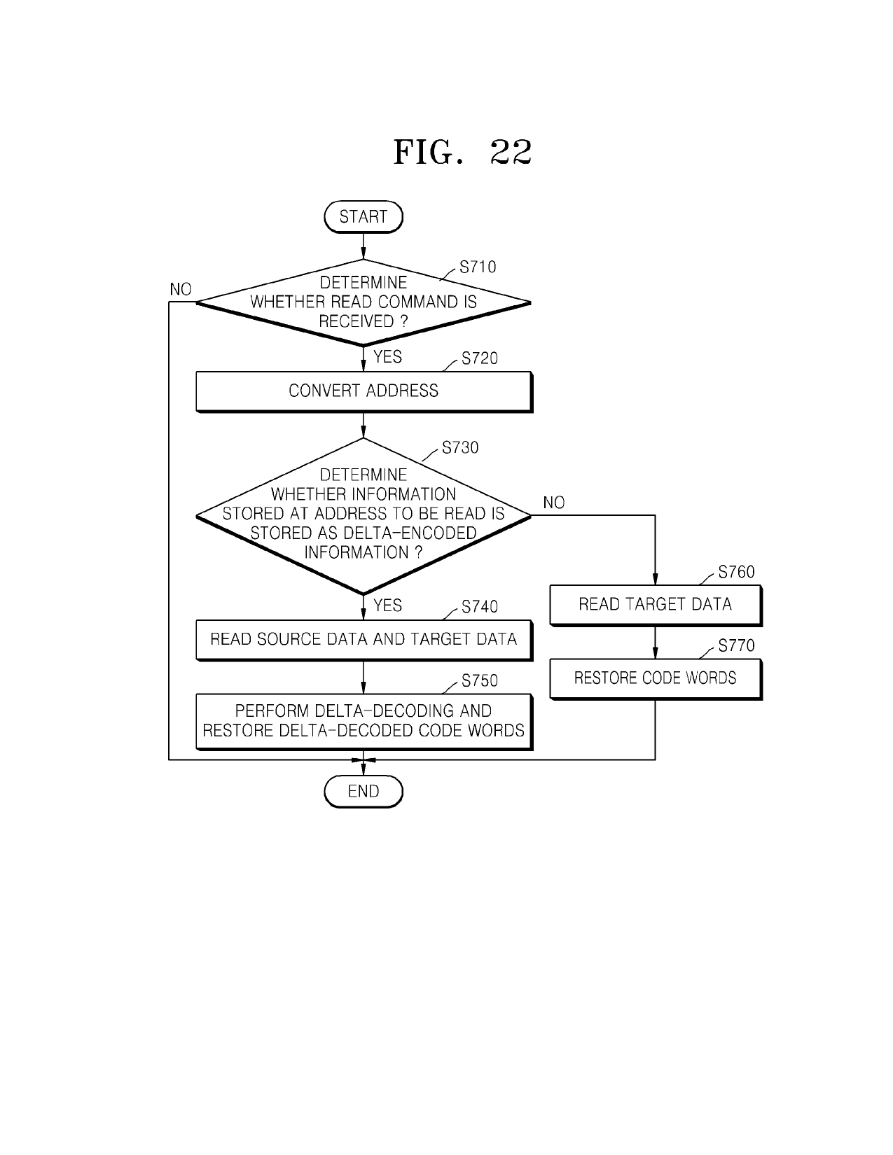

FIG. 22 is a flowchart illustrating a data read operation performed in the storage device 120 of the data storage system 1000 of FIG. 1. The method of FIG. 22 may be performed under the control of the control unit 121-3 of FIG. 3 or 4.

In operation S710, the control unit 121-3 determines whether a read command is received from the host device 110 to the storage device 120.

When it is determined in operation S710 that the read command is received, the method proceeds to operation S720. In operation S720, the control unit 121-3 converts a logical address into a physical address by using the mapping table information MT. For example, when the memory device 122 includes a flash memory, a physical address is converted into a physical page number.

In operation S730, the control unit 121-3 determines whether information stored at the physical address obtained in operation S720 is stored as delta-encoded information by using the mapping table information MT. As described above, delta-encoded information is registered in the mapping table information MT such that a physical address at which the source code words used during the delta-encoding are stored is matched to a physical address of the memory device 122 at which the delta-encoded information is stored. Accordingly, when information about the source code words at the physical address is registered, it may be determined that the information is stored as delta-encoded information.

When it is determined in operation S730 that the information is stored as delta-encoded information, the method proceeds to operation S740. In operation S740, the control unit 121-3 reads source data and target data from the memory device 122 and respectively stores the source data and the target data in the first buffer area 121-2b and the second buffer area 121-2c of the RAM 1221-2. In detail, the control unit 121-3 finds a physical address at which the source data is stored by using the mapping table information MT, reads the source data stored at the physical address, and stores the source data in the first buffer area 121-2b. The target data stored at the physical address obtained in operation S710 is read from the memory device 122 and is stored in the second buffer area 121-2c.

In operation S750, the control unit 121-3 performs a process of performing delta-decoding on the target data stored in the second buffer area 121-2c based on the source data stored in the first buffer area 121-2b to obtain delta-decoded code words, and restoring the delta-decoded code words.

Otherwise, when it is determined in operation S730 that the information is stored as delta-encoded information, the method proceeds operation S760. In operation S760, the control unit 121-3 reads the target data and stores the target data in the first buffer area 121-2b of the RAM 121-2. In detail, the control unit 121-3 reads the target data stored at the physical address obtained in operation S710 from the memory device 122 and stores the target data in the first buffer area 121-2b.

In operation S770, the control unit 121-3 performs a process of restoring the code words stored in the first buffer area 121-2b.

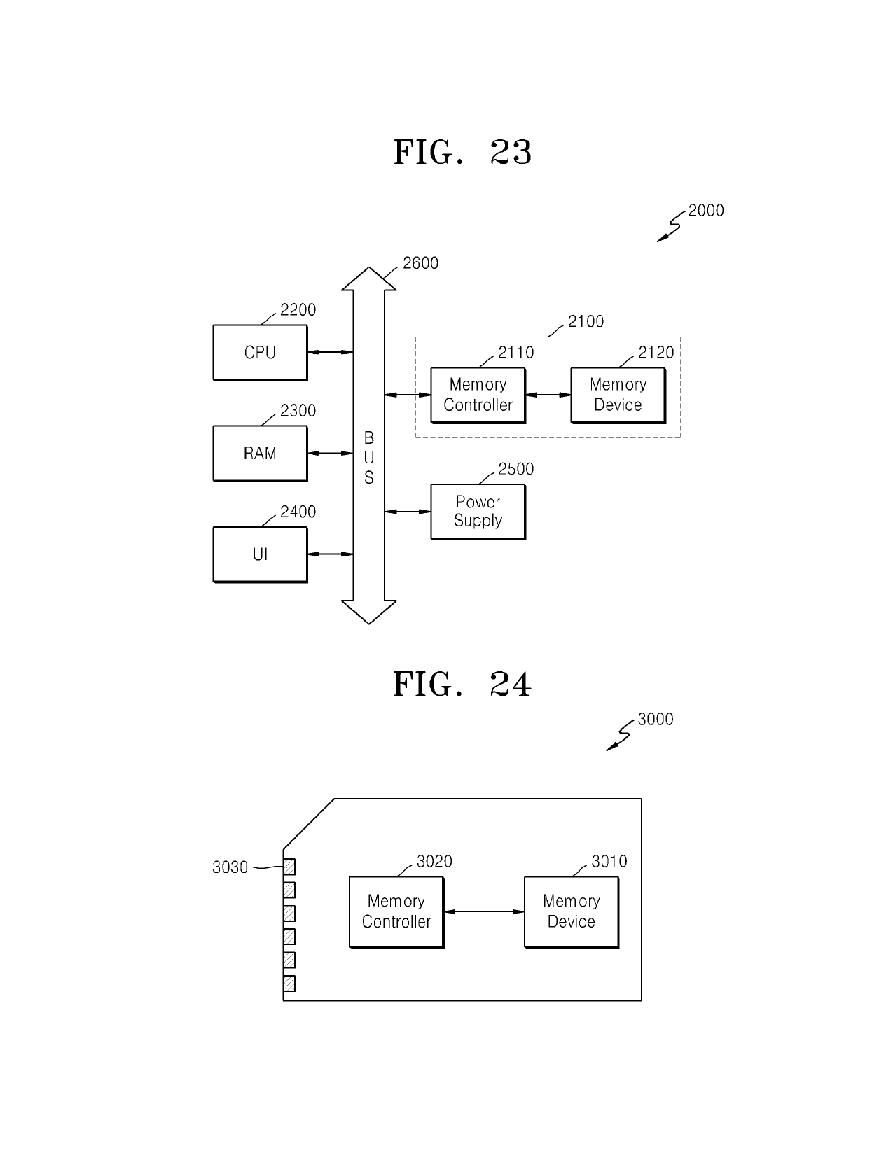

FIG. 23 is a block diagram illustrating a computer system 2000 according to some example embodiments of the inventive concept.

Referring to FIG. 23, the computer system 2000 includes a processor (e.g., a central processing unit (CPU)) 2200, a RAM 2300, a UI 2400, and a storage device 2100 which are electrically connected to a bus 2600. The storage device 2100 includes a memory controller 2110 and a memory device 2120. Data processed or to be processed by the processor 2200 is stored by the processor 2200 in the memory device 2120 through the memory controller 2110. The storage device 120 of FIG. 1 may be applied to the storage device 2100 of FIG. 23. The computer system 2000 may further include a power supply device 2500.

If the computer system 2000 is a mobile device, the power supply device 2500 of the computer system 2000 may be a battery, and a modem such as a baseband chipset may be additionally provided. It would be obvious to one of ordinary skill in the art that an application chipset, a camera image processor (CIS), or a mobile DRAM may be further provided to the computer system 2000, and thus a detailed explanation thereof will not be given.

FIG. 24 is a block diagram illustrating a memory card 3000 according to some example embodiments of the inventive concept.

Referring to FIG. 24, the memory card 3000 includes a memory controller 3020 and a memory device 3010. The memory controller 3020 controls a data write operation to the memory device 3010 or data read operation from the memory device 3010 in response to a request of an external host received through an input/output unit 3030. To this end, the memory controller 3020 of the memory card 3000 may include an interface and a RAM for interfacing with the external host and the memory device 3010. The memory card 3000 of FIG. 24 may be embodied as the storage device 120 of FIG. 1.

Examples of the memory card 3000 of FIG. 24 may include a compact flash card (CFC), a micro drive, a smart media card (SMC), a multimedia card (MMC), a security digital card (SDC), a memory stick, or a USB flash memory driver.

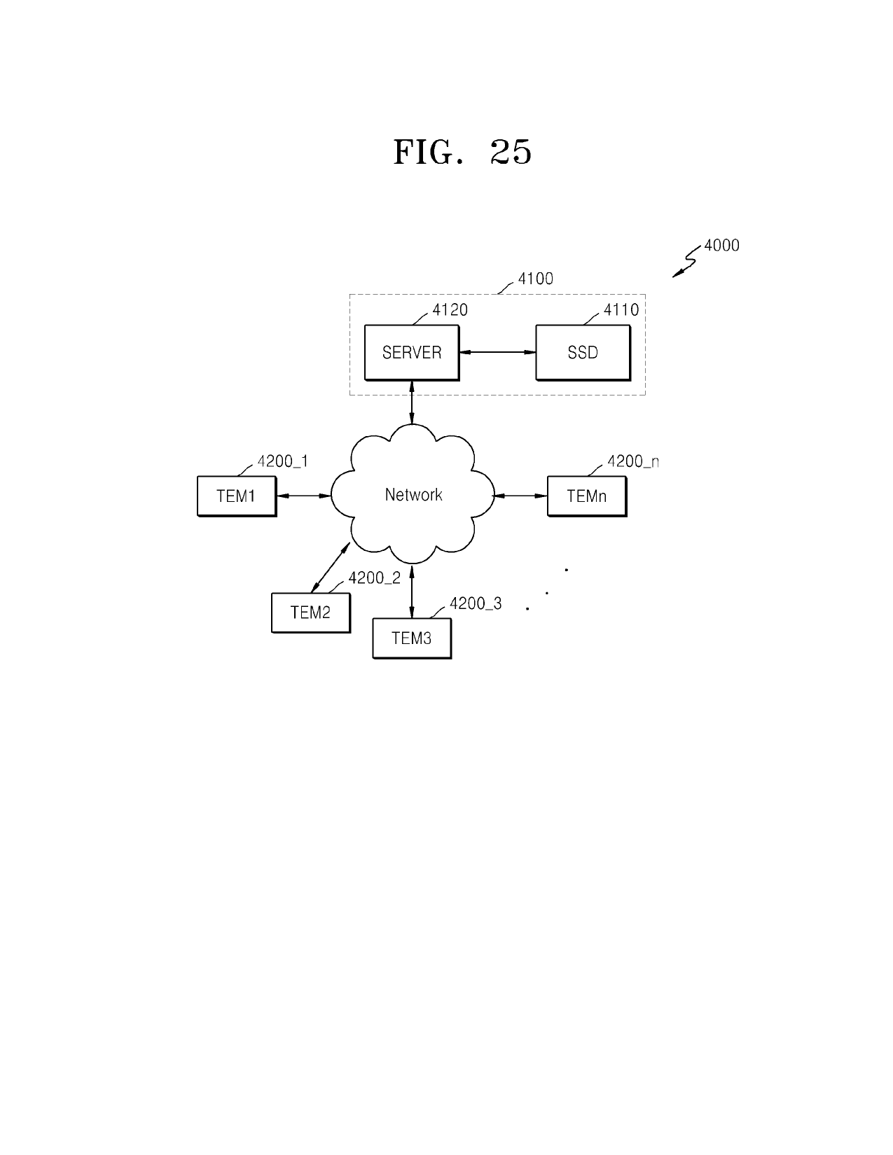

FIG. 25 is a block diagram illustrating a network system 4000 including a server system 4100 that includes an SSD 4110, according to some example embodiments of the inventive concept.

Referring to FIG. 25, the network system 4000 may include the server system 4100 and a plurality of terminals 4200_1 through 4200_n that are connected through a network. The server system 4100 may include a server 4120 that processes requests received from the plurality of terminals 4200_1 through 4200_n and the SSD 4110 that stores data corresponding to the requests received from the plurality of terminals 4200_1 through 4200_n. In this case, the SSD 4110 of FIG. 25 may be embodied as the storage device 120 of FIG. 1.

A flash memory system may be mounted in various packages. For example, a flash memory system may be mounted in packages such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metricQuad flat pack (MQFP), thin quad flatpack (TQFP), small outline (SOIC), shrink small outline package (SSOP), thin small outline (TSOP), thin quad flatpack (TQFP), system in package (SIP), multi-chip package (MCP), wafer-level fabricated package (WFP), or wafer-level processed stack package (WSP).

While example embodiments have been particularly shown and described, it will be understood by those of ordinary skill in the art that various changes in form and details may be made therein without departing from the spirit and scope of the present invention as defined by the following claims.

What is claimed is:

1. A method of compressing and storing data, the method comprising:
generating target code words by compressing target data to be stored in a memory device by using an initially set compression algorithm; and
storing in the memory device the target code words, according to a data pattern that is repeated in the target code words, or storing in the memory device delta-encoded information, obtained by performing delta-encoding on the target code words based on source code words including the data pattern.

2. The method of claim 1, wherein the storing comprises:
extracting the data pattern;
searching for a storage location of the source code words including the data pattern by using pattern table information; and
writing to the memory device the target code words or delta-encoded information that is obtained by performing the delta-encoding on the target code words based on the source code words according to a search result of the pattern table information;
wherein the pattern table information comprises the data pattern and location information of the memory device about a storage location where code words including the data pattern are stored.

3. The method of claim 2, wherein the searching comprises:
assigning a weight value to the data pattern based on a number of times the data pattern is repeated in the target code words; and
searching for the source code words in the pattern table information based on the weight value assigned to the data pattern.

4. The method of claim 3, wherein when a plurality of candidates of the source code words are found in the pattern table information, the source code words are selected by assigning a priority to a data pattern having a largest weight value.

5. The method of claim 3, wherein when a plurality of candidates of the source code words are found in the pattern table information, the source code words having a large similarity are selected from the plurality of candidates of the source code words by considering a length of the data pattern and the weight value.

6. The method of claim 2, wherein the writing comprises:
when the data pattern is not registered in the pattern table information, writing the target code words to the memory device;
when the data pattern is registered in the pattern table information, performing delta-encoding on the target code words based on the source code words to obtain the delta-encoded information; and
writing the delta-encoded information to the memory device.

7. The method of claim 6, further comprising:
when the data pattern is not registered in the pattern table information, registering the data pattern in the pattern table information.

8. The method of claim 2, wherein when the delta-encoded information is written to the memory device, the data pattern that is used to search for the source code words is not registered in the pattern table information.

9. The method of claim 1, further comprising:
calculating a compression ratio of the target data;
wherein when the compression ratio is equal to or greater than a first threshold value, the target code words are stored in the memory device without performing the delta-encoding.

10. The method of claim 1, further comprising:
calculating a match rate of the target code words and the source code words;
wherein when the match rate is less than a second threshold value, the target code words are stored in the memory device.

11. The method of claim 1, further comprising:
detecting a file format of the target data;
wherein when the file format of the target data is included in a range of an initially set file format, the target code words are stored in the memory device without performing the delta-encoding.

12. The method of claim 1, wherein the compressed target code words indicate a repeated data pattern expressed in a form of (offset, length), the delta-encoded information indicates a common data pattern between the target code words and the source code words expressed in a form of (flag, offset, length), and the flag indicates the existence of a source file.

13. The method of claim 1, wherein the initially set compression algorithm comprises a Lempel-Ziv-Storer-Szymanski (LZSS) algorithm.

14. A storage device, comprising:
a memory device that stores information; and
a memory controller that performs a process of generating target code words by compressing target data by using an initially set compression algorithm during a write operation performed on the target data, and storing in the memory device the target code words according to a data pattern that is repeated in the target code words or storing in the memory device delta-encoded information that is obtained by performing delta-encoding on the target code words based on source code words including the data pattern.

15. The storage device of claim 14, wherein the memory controller comprises:
a volatile memory unit that temporarily stores mapping table information and pattern table information;
a compressor that inputs the target data and outputs the target code words that are obtained by compressing the target data by using the initially set compression algorithm; and
a control unit that performs a process of extracting the data pattern when the data pattern is registered in the pattern table information, performing delta-encoding on the target code words to obtain delta-encoded information and writing to the memory device the delta-encoded information based on the source code words read from the memory device by using the pattern table information, and when the data pattern is not registered in the pattern table information, registering in the pattern table information the data pattern and writing the target code words to the memory device.

16. A method of compressing and storing data, the method comprising:
generating target code words by compressing target data to be stored in a memory device by using an initially set compression algorithm; and
storing in the memory device the target code words or delta-encoded information obtained by performing delta-encoding on the target code words according to a data pattern in the target code words.

17. The method of claim 16, wherein the storing comprises:
extracting the data pattern;
searching for a storage location of source code words including the data pattern that is repeated in the target code words by using pattern table information; and
writing to the memory device the target code words when the data pattern is not registered in the pattern table information;
wherein the pattern table information comprises the data pattern and location information of the memory device about a storage location where code words including the data pattern are stored.

18. The method of claim 16, wherein the storing comprises:
extracting the data pattern;
searching for a storage location of source code words including the data pattern by using pattern table information; and
writing to the memory device the delta-encoded information that is obtained by performing the delta-encoding on the target code words based on the source code words;
wherein the pattern table information comprises the data pattern and location information of the memory device about a storage location where code words including the data pattern are stored.

19. The method of claim 18, wherein the searching comprises:
assigning a weight value to the data pattern based on a number of times the data pattern is repeated in the target code words; and
searching for the source code words in the pattern table information based on the weight value assigned to the data pattern.

20. The method of claim 18, wherein delta-encoding is performed on the target code words based on the source code words to obtain the delta-encoded information and the delta-encoded information is written to the memory device when the data pattern is registered in the pattern table information.
